(19) United States
(12) Patent Application Publication
(10) Pub. No.: US 2018/0176272 A1
(43) Pub. Date: Jun. 21, 2018

(54) SYSTEM, DEVICE, AND METHOD FOR INTERACTIVE COMMUNICATIONS AMONG MOBILE DEVICES AND IP-CONNECTED SCREENS

(71) Applicant: Screemo Ltd., Tel Aviv (IL)

(72) Inventors: Yonatan Zur, Jerusalem (IL); Adir Zimerman, Tel Aviv (IL); Dotan Kopolovich, Timrat (IL); Nitzan Bar, Nes Ziona (IL); Israel Krush, Tel Aviv (IL)

(21) Appl. No.: 15/127,424

(22) PCT Filed: Apr. 21, 2015
(86) PCT No.: PCT/IB2015/052892

§ 371 Date: Sep. 20, 2016

(51) Int. Cl. H04L 29/06; H04W 88/04; G06F 8/38; H04L 29/08; H04W 52/02; H04W 48/18

(52) U.S. Cl. CPC H04L 65/4015; H04W 88/04; G06F 8/38; H04W 12/06; H04L 65/80; H04W 52/0229; H04W 48/18; H04L 67/36

(57) ABSTRACT

Device, system, and method of interactive communications among mobile devices and Internet Protocol (IP) connected screens. A system enables rapid and efficient generation of an interactive application, that has a screen-side component able to nm on IP-connected screen, and that has a mobile-side component able to run on smartphones, tablets, smart-watches, and other mobile electronic devices. User feedback from an end-Dashboard Module user device, or aggregated user feedback from multiple end-user devices, interacts with and affects the interactive application as displayed on the IP-connected screen. The system enables the interactive application to run and to operate automatically at a sports venue, a digital billboard or digital sign, or at other suitable venues.

### CROSS-REFERENCE TO RELATED APPLICATIONS

This application claims priority and benefit from U.S. provisional patent application No. 61/982,392, titled “System device and method for interactive communications among mobile devices and IP connected digital screens”, filed on 22 Apr. 2014, which is hereby incorporated by reference in its entirety.

This application claims priority and benefit from U.S. provisional patent application No. 62/027,803, titled “Automatically remote controlling operating and monitoring an interactive experience among mobile devices and IP connected digital screens”, filed on 23 Jul. 2014, which is hereby incorporated by reference in its entirety.

### FIELD OF THE INVENTION

The invention relates to the field of electronic communications.

### BACKGROUND

Millions of people use portable electronic devices for daily communications. For example, cellular phones and smartphones are used to allow two persons to conduct a voice conversation. Similarly, a first user may utilize a video conferencing application, such as Skype or FaceTime, to conduct a video conference with a second user.

Users may further utilize electronic devices for various other purposes, for example, sending and receiving electronic mail (email) messages, engaging in Instant Messaging (IM), capturing images and video, playing games, browsing the Internet, or the like.

### SUMMARY

The present invention may comprise devices, systems, and methods of wireless interactive communication between (i) an Internet Protocol (IP) connected screen, and (ii) one or more mobile electronic devices operated by one or more users. The mobile electronic device may be, for example, a smartphone, a tablet, a phone-tablet (“phablet”), a smart-watch, a smart-bracelet or fitness-bracelet, an Augmented Reality (AR) item or glasses or helmet, a portable gaming device, a wearable electronic device, or other suitable electronic device(s).

For example, a cloud-based platform or system may allow designers to efficiently and rapidly develop a web-based application, which may be played on the IP-connected screen. The application may communicate, via a communication server, with a single mobile electronic device, or with many mobile electronic devices; and may receive from such mobile electronic device(s) user inputs or user feedback, for example, indicating user selection or user operations that are performed on such mobile electronic device(s). The display shown on the IP-connected device may be updated or may be modified, in response to the user input received from the single mobile electronic device; or in response to the aggregated audience feedback that is received from multiple such mobile electronic devices.

The present invention may further comprise a technique for efficiently utilizing cellular network(s) and/or other wireless network(s), including low-bandwidth or low-quality networks, in order to enable two-way communication between the IP-connected screen and the one-or-more mobile electronic device(s). For example, a server may utilize WebSockets protocol (or other suitable communication protocols) to enable real-time communication and to wirelessly communicate with many mobile electronic devices; but may selectively switch to utilizing wireless Polling method(s) if the server estimates that current network conditions have deteriorated. Additionally or alternatively, in order to preserve bandwidth and to hasten the wireless communications, the server may utilize data versioning in order send to the mobile devices only changed or updated data-portions or application-parts; while the mobile electronic devices may store and may keep in their cache a re-usable web-application component or “controller module”.

The present invention may provide other and/or additional benefits or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block-diagram illustration of a system, in accordance with some demonstrative embodiments of the present invention;

FIG. 2 is a schematic block-diagram illustration of a cloud-based system, in accordance with some demonstrative embodiments of the present invention;

FIG. 3 is a flow-chart of a method of creating an interactive application, in accordance with some demonstrative embodiments of the present invention;

FIG. 4 is a flow-chart of a method of controlling an interactive application, in accordance with some demonstrative embodiments of the present invention;

FIG. 5 is a schematic block-diagram illustration of a system, in accordance with some demonstrative embodiments of the present invention;

FIG. 6 is a schematic illustration of a system demonstrating multiple user-case scenarios related to a consumer or an end-user of a mobile electronic device, in accordance with some demonstrative embodiments of the present invention;

FIG. 7 is a flow-chart of a method of creating an interaction file, in accordance with some demonstrative embodiments of the present invention;

FIG. 8 is a flow-chart of a method of managing an interaction file, in accordance with some demonstrative embodiments of the present invention; and

FIG. 9 is a schematic flow-chart of a method of enabling communication and facilitating interactions between an end-user mobile device and an IP-connected screen, in accordance with some demonstrative embodiments of the present invention.

### DESCRIPTION OF SOME DEMONSTRATIVE EMBODIMENTS OF THE PRESENT INVENTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

The present invention may provide solutions and systems in the field of digital signage. More specifically, the present invention may facilitates interactions between: (A) mobile devices (such as mobile phones, cellular phones, smartphones, tablets, phone-tablet or “phablet” devices, laptop computers, netbook computers, notebook computers, or the like), and (B) Internet Protocol (IP) connected or IP-enabled or IP-supporting digital signs (or digital screens), over a wireless communication network or over wireless communication link(s) (e.g., via the Internet, a Wi-Fi network, a Wi-Max network, cellular network, 2G network, 3G network, 3.5G network, 4G network, 4G LTE network, a combination of wireless networks and/or cellular network, or the like).

The present invention may provide applications allowing these interactions, and the present invention allows such interactive applications to be efficiently created, designed, managed, monitored, operated, controlled, modified, distributed and/or connected; in an efficient manner that does not require developers, programmers and/or coding professionals. It is clarified that the terms “application”, “app”, “mobile app”, “web-based app”, “browser-based app”, “interactive app”, or similar terms, may relate and may include any suitable application which enables interaction(s) between one-or-more mobile electronic devices and one-or-more IP-connected screens; and such “interactive app” may be generated and created efficiently, in accordance with the present invention, using one or more suitable techniques (e.g., using HTML5, using CSS, using JavaScript, using Adobe Flash, using native programming language, or the like). It is clarified that any portions of the discussion herein, that relate to a Flash application or to a Flash file, are non-limiting examples for demonstrative purposes only; and the interactive application(s) of the present invention may be constructed by other (non-Flash) technologies or programming language(s) or scripts.

The present invention may further provide platform enabling a novel way of creating, designing, distributing, managing, measuring and monitoring these applications, for example, using a cloud based service (e.g., implemented as SaaS—Software as a Service), or using other suitable architectures (e.g., client-server, peer-to-peer, distributed architecture, centralized architecture, or the like).

The present invention may further enable accumulation and analysis of information and data regarding these interactions, such as statistics and analytics, via the cloud servers or other suitable server(s). The accumulation and aggregation of data may then be utilized for data mining and data analysis, for generating analytics and Business Intelligence (BI) insights and “best practice” recommendations or suggestions or insights; and in order to automatically deduce and generate recommendations and improvements. As a demonstrative example, accumulation and aggregation of data, and then analysis of data, in relation to a particular sports-related trivia-questions game, may be extrapolated or utilized for deducing insights and/or recommendations for other sports-related games, and/or for other trivia-questions game(s) in other field(s).

Applicants have realized that in the prior art, designing an interactive application to allow users to use their mobile smartphones in order to interact with a digital screen (such as digital signage screens, digital out-of-home screens, smart TV, or the like) requires a complicated process that involves multiple entities and a complex “chain of supply”. For example, only after the application design is prepared and finalized by designers, then programmers are required for front-end design, back-end design, server integration (Internet servers, local servers, or the like) and/or specific screen-players integration in the development process. Furthermore, in a conventional system, once the application is programmed and developed, it is typically non-module and non-reusable, and the deployment or the introduction of any minor modification to the application typically requires high costs of employing programmers or developers.

Applicants have realized that the designers may use design software such as Adobe Flash or Adobe After Effects to create the creative elements of the content shown on the digital sign (commercials, games, or the like), and also design the mobile application used to control this interaction; however, such designs are “static” and have to be coded by the programmers or developers. This is typically a long and expensive process, which may be time-consuming, effort-consuming, complex to implement and manage, error-prone, and expensive, a process that demands multiple human experts in order to take the designer's application designs and make from them an operational application.

Applicants have realized that the prior art lacks the ability to easily and efficiently create interactions and experiences of this kind, among mobile devices and digital screens or digital signs. Furthermore, Applicants have realized that the creative teams creating the designs are strangers to the developers and code worlds, and that the process of involving developers into the design process is a practice they prefer not to deal with.

Applicants have realized that the prior art lacks any cross-platform cloud-based solution that is not part of a specific system, thereby making the interactive signage market a very complicated and segmented one that suffers from the above-mentioned problems.

The present invention comprises a cloud based SaaS (Software as a Service) platform, r other suitable platform or system, enabling the efficient design, creation, computing, distribution, management and measurement statistics and analytics of interactive applications, thereby allowing real-time two-way interaction between mobile devices (such as smartphones and tablets) with digital IP-connected signs or screens, such as advertising billboards of any size, computer screens, smart TVs, and other IP-connected screen.

The present invention comprises a cloud-based server service for computing, preparing, generating and saving the created applications (“apps”), and for further providing the statistics and analytics of usage of such apps; optionally utilizing a web-based or browser-based user interface for laptop/desktop computers or smartphones/tablets or other devices, the user interface enabling administration, creation, management, distribution and monitoring of such apps. The present invention may provide a mobile technological framework which may be downloaded to the end user's smartphone or cellular phone or mobile phone, as a web app or a native app, and/or a plug in for designers added to their design environment such as Adobe Flash and/or HTML code in order to facilitate the generation and the operation of such interactive apps from within the design software environment(s), and/or as OEM module or OEM technology which may be pre-built or integrated or added into a software product (e.g., Flash, PowerPoint, or the like).

The system of the present invention may allow a designer to design and to create an interactive app and screen content (as well as control logic of the interactive application and definition of the flow of the interactive application) using the plug in or using the web interface, without leaving his design environment (e.g., Adobe Flash or HTML5); and/or by using a web creation interface, and/or without the need for adding or including software developers (e.g., programmers, code developers) in the process. The designer may utilize the system of the present invention in order to efficiently design both the digital content for the digital screen, then the mobile app interface, and then connect both and upload them to the SaaS platform where it generates an interactive app or file. The interactive file(s), such as a Flash file or an HTML file (e.g., HTML-5 file(s), optionally utilizing CSS or JavaScript and/or other techniques), may then be downloaded or viewed by virtual any end-user device (“client”) and may be used on digital sign players and systems. The invention this provides a full “eco system” for rapidly and efficiently generating interactive apps, eliminating or reducing the need for software and application developers.

The SaaS User Interface (UI), available on mobile browsers and/or desktop/laptop browsers, may include areas where interactive apps may be uploaded or downloaded, design areas allowing design modifications and alterations from within the SaaS platform, management area to control the apps (such as, start and stop them), statistics and analytics area to view and monitor and manage the apps performance, and social areas including a blog, sharing modules, content publishing modules, modules for creating and/or modifying and/or sharing and/or publishing user content, and other suitable options.

The present invention may be implemented as a Software as a Service (SaaS) platform which enables content creators (creative teams and designers) to design and create in an easy way, engaging interactive experiences between any digital components. The system enables the creation of mobile-to-screen interactive experiences, which are deployed on digital IP-connected screens, optionally by using a Content Management System (CMS) which may be optional but need not necessarily be required. The content items generated by the present invention are delivered in rapid development cycles, enabling customers to be constantly up-to-date and efficiently create and deploy the latest high-quality digital interactive experiences.

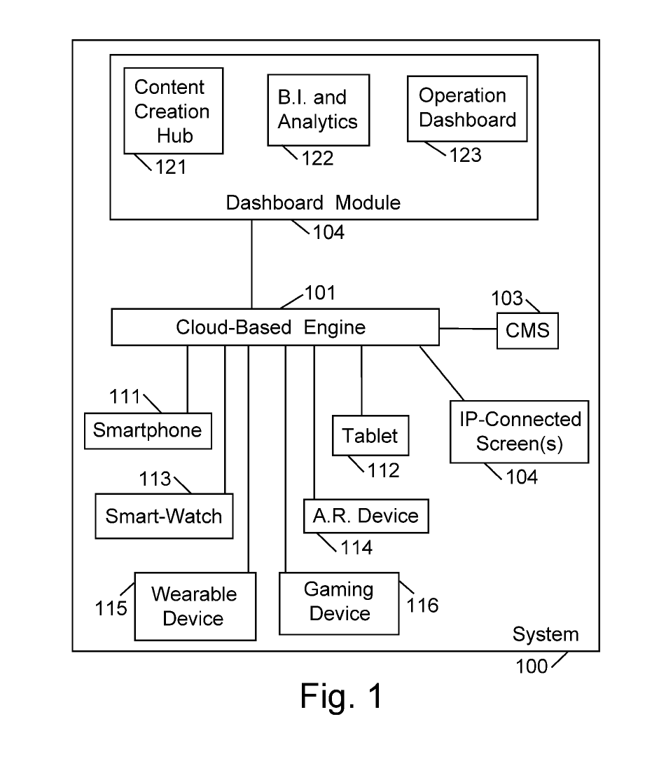

Reference is made to FIG. 1, which is a schematic block-diagram illustration of a system 100, in accordance with some demonstrative embodiments of the present invention. System 100 may be implemented using suitable hardware components and/or software modules.

System 100 may comprise a cloud-based engine 101, able to control other components of system 100; and able to serve data to, and receive data from, other components of system 100. The cloud-based engine 101 enables the creation of interactive experiences, and manages and controls the interactive experiences in dynamic real-time manner.

System 100 may comprise, or may be connected to (e.g., wirelessly), an IP-connected screen 102 or other suitable display unit. The IP-connected screen 102 may be, for example, a large digital screen in a sports venue or arena or stadium; a set of group or batch of discrete screens or of interconnected screens; a digital advertising screen or billboard on which digital content may be displayed; a digital advertising screen located at (or near) a shop or a store or other retailer venue or commerce venue; a digital screen located in other locations (e.g., at a bus-stop or train-stop or subway-stop; at a gas station; at or near or within a vending machine or automated vending machine, or Automatic Teller Machine (ATM) or other “kiosk” type machine or device or system; at a bank or banking center, or at a financial services center; at an entertainment center or venue; at an arts center or venue; at a transportation hub; on a road or highway; inside a mall or shopping area); or the like.

In a demonstrative implementation, the IP-connected screen 102 may display or may play-back an interactive experience file that may be able to run on any digital screen infrastructure. Optionally, the interactive experience file may run on (or through, or in association with) a CMS module 103 (e.g., CMS server or CMS software) which may manage or control the digital signage content, for example, by utilizing a playlist timeline module. In a demonstrative implementation, the IP-connected screen 102 may contain all the relevant graphic assets; may be implemented as a Flash file (SWF file); and may be controlled by the cloud-based engine 101. Other suitable file formats or structures may be used (e.g., using HTML5, using JavaScript, using CSS, using native programming language, or the like).

The cloud-based engine 101 may be in communication with one or more wireless electronic devices, for example, a smartphone 111, a tablet 112, a smart-watch 113, an Augmented Reality (AR) device 114, a wearable device 115, a portable gaming device 116, and/or other suitable electronic devices or portable devices which may be operated by end-users. The wireless communication may utilize Wi-Fi, Wi-Max, wireless LAN communication, cellular communication, 3G, 4G, 4G-LTE, and/or other suitable wireless communication protocols or standards. In some implementations, each end-user device may comprise, or may run, a lightweight client-side (end-user device side) controller application, which may be implemented (for example) as a Web-based application (e.g., utilizing HTML5/CSS3).

The system's dashboard module 104 may be a back-office gate or portal, which allows customers to create new interactions, to edit previously-created interactions, to play interactions (e.g., on the IP-connected screen 102 and/on the end-user devices), to obtain statistics analytics, and to manually operate or control specific interactions.

In a demonstrative implementation, the dashboard module 104 may comprise multiple sub-modules, for example: (A) a content creation hub 121, which enables content creators to design, create and modify the interactive experience components (e.g., mobile side, screen side, and control logic), and which then parses the digital assets and settings to the system's other components; (B) a Business Intelligence (BI) and Analytics module 122, which generates and shows statistics and analytics of the interactive experiences, and which allow measuring the user engagement with the system and translate this to Return on Investment (ROI) and to other parameters; (C) an Operation Dashboard 123, which enables manual operation of the interactive experience state for a specific event.

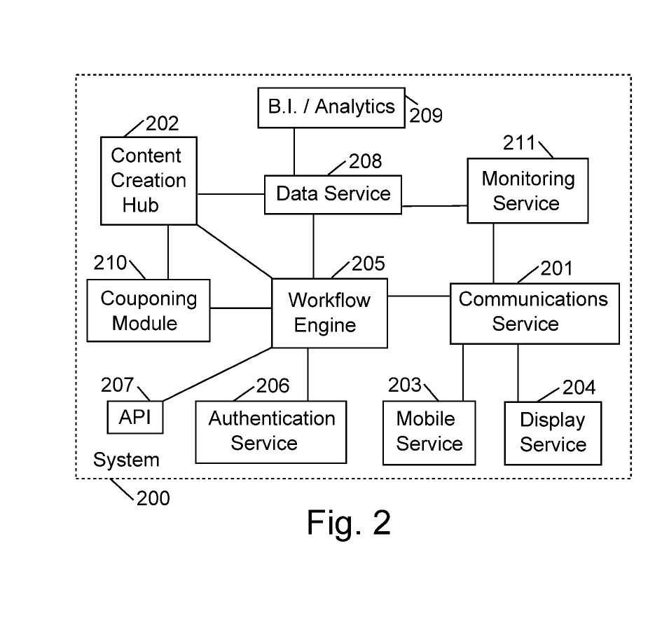

Reference is made to FIG. 2, which is a schematic block-diagram illustration of a cloud-based system 200, in accordance with some demonstrative embodiments of the present invention. System 200 may be implemented using suitable hardware components and/or software modules. System 200 may be a demonstrative implementation of system 100 of FIG. 1, or may be a demonstrative implementation of cloud-based engine 101 of FIG. 1.

System 200 may comprise, for example, a communication service 201, a content creation hub service 202, a mobile service 203, a display service 204, a workflow engine 205, authentication service 206, an external API service 207, a data service 208, a BI/Analytics service 209, a couponing module 210, and a monitoring service 211.

Communication service 201 (or communication module) may connect (and allows inter-communication) among all the system components. Communication service 201 allows maximum stability during usage, while balancing real-time communication and preventing an overload of the network infrastructure (e.g., at a live event which takes place at a large venue, such as sports arena or stadium). Communication service 201 may utilize web-sockets, Socket.IO, REST, Polling methods, Transmission Control Protocol (TCP), User Datagram Protocol (UDP), and/or other suitable communication methods. In the discussion herein, any one or more of these communication methods and/or protocols, may be used as appropriate or as determined by the system to provide the most suitable communication in view of current network conditions and/or in view of other parameters that the system may take into account (e.g., network congestion, latency, delay, number of mobile devices communicating, signal strength, whether the interactive application requires real-time or substantially-real-time user feedback, whether the interactive application may be efficiently utilized when the user feedback is lagging by a few seconds, or the like).

Content Creation hub service 202 may allow to upload assets (e.g., graphic files, audio files, video files, images, audio/video files, text components) and to set or modify settings (e.g., including the definitions of the interactions and the flow of the interactive app); and such data may be uploaded to the creation hub or may be directly created on or through the creation hub, for the other services or modules of the system.

Mobile service 203 may generate or create the interactive mobile application (e.g., as HTML5 application, or as a native application, or using other suitable structure), based on the assets that were uploaded and the settings and flow that were defined through the content creation hub service 202. Optionally, the system may parse the pre-defined controller configurations and configures the HTML/CSS properties of the system's mobile (end-user) side, for the specific interactive experience which is intended to run on the end-user device(s).

Display service 204 parses the pre-defined screen configurations and configures the Flash Loader properties, which will present the interactive content of the system's screen for the specific interactive experience.

Workflow engine 205 operates all the flows by binding data and events to elements, making them interactive, and triggering them according to pre-defined rules of the specific experience.

Authentication service 206 operates the authentication procedure with the system, directly and/or via one or more social networks (e.g., Facebook, Twitter); by utilizing OpenID or other suitable protocols or standards or procedures (e.g., using OAuth; using Security Assertion Markup Language (SAML); using XML or XML-based formats or structures; using Cookie files, using tokens, or other suitable items).

External API service 207 provides an Application Programming Interface (API) for integration with external systems; for example, by enabling the creation of events and/or the sending of events to external systems, by the workflow engine 205, which will interact with such external systems.

Data Service 208 may comprise (or may be associated with) a Data Application Layer (DAL) service which provides access to the system's repositories and/or databases.

BI/Analytics service 209 analyzes the data using map-reduce and Extract-Transform-Load (ETL) methods, and creates recommendations to improve the engagement with the end users. The accumulation and aggregation of data may be utilized for data mining and data analysis, for generating analytics and Business Intelligence (BI) insights and “best practice” recommendations or suggestions or insights; and in order to automatically deduce and generate recommendations and improvements.

Couponing module 210 may comprise a couponing-generating module which provides each coupon a Universally Unique Identifier (UUID); and further defines, controls and manages coupon-issuing and coupon-redemption.

Monitoring service 211 provides a real-time monitoring of the active screens and/or the mobile device(s), and generates real-time alerts, notifications, and/or reports. Optionally, the monitoring service 211 may be configured to automatically detect pre-defined errors or communication problems, and to automatically launch or trigger or deploy pre-defined remedial actions or solutions or alternate content. In a demonstrative example, the monitoring service 211 may detect a wireless communication failure, and may automatically trigger or activate the presentation or the play-back of a pre-defined message or audio/video clip.

The system's platform may allow rapid and easy creation of interactive apps that may be utilized by many mobile devices as well as one-or-more IP-connected screens. A process that in the prior art took months or many weeks, may be performed by utilizing the present invention within a few hours or a few days.

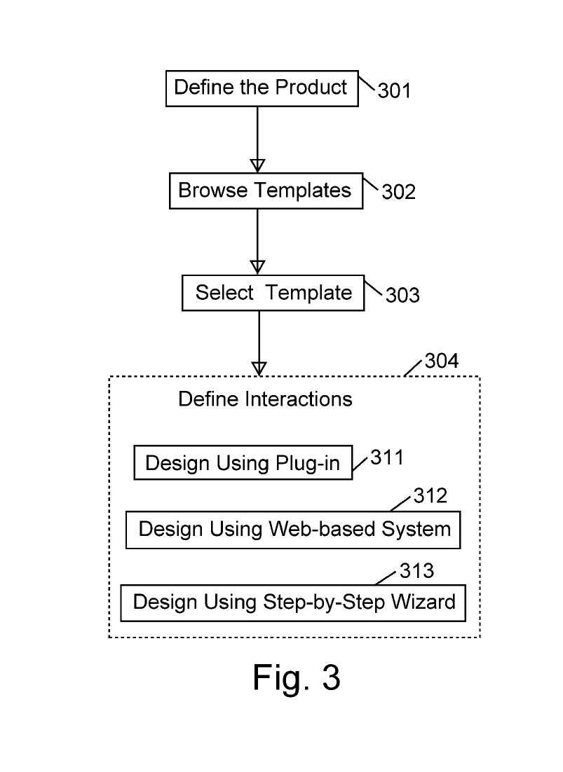

Reference is made to FIG. 3, which is a flow-chart of a method of creating an interactive application, in accordance with some demonstrative embodiments of the present invention. In accordance with the present invention, the process of creating an interactive app may begin, for example, by creating the main Flash or animation file that is intended to be displayed on the IP-connected screen.

Step 301 may include product definition: the product(s) may be defined, by determining or defining which interaction(s) will take place. For an example, a sport-related client (e.g., a sports venue owner, a sports team, or the like) may decide that it wants a “tug of war” game and decide if it will be divided between two teams playing, or males against females, or four teams competing, or other options based on various creative options, which may be based on pre-defined examples or templates or a step-by-step wizard module as explained herein.

Step 302 may include browsing a list of available templates, and Step 303 may include selecting an interaction template. For example, if the client does not wish to deal with the creative part (or, if the designer does not wish to deal with the logic-creation part and only wishes to prepare the design), he may request and get a suggestion for the interaction from the system, for example, based on previous templates or examples or based on application types that the client may browse (e.g., sports-oriented, fashion-oriented, travel-oriented, trivia-game applications, competition applications, or the like).

Step 304 may include, once the interaction or interactions are defined, the design of the application; for example, by utilizing several options. For demonstrative purposes, three options are shown (box 311, box 312, box 313); two or more of the options may be used in combination; and the options may be used or may be presented in other order(s) or sequence(s). For demonstrative purposes only, the three boxes 311-313 are shown in FIG. 3 as options within the box of step 304. It is further noted that, although portions of the discussion herein may relate to a Flash file (for demonstrative purposes), other suitable programming solutions or languages may be utilized by the system (e.g., using HTML5, JavaScript, CSS, native programming language, or the like).

In a first option 311, the client designs the Flash file using his own designers, or using freelance designers, by downloading the system's plug-in for Flash. This allows the client to have full creative control. The designers also create the mobile controller (the web application for the smartphone or tablet) without needing any code or developers, by using drag-and-drop and design logics, from within the Flash development program or on the system's website; and optionally by utilizing a step-by-step creation “wizard” tool. Once done, the file loads to the system's cloud server where it is automatically converted into an interactive app that has mobile (end-user device) components and IP-connected screen components, interacting with each other. The interactive app may then be downloaded and played on any suitable CMS (Content Management Software), or played directly from the web using the system's website or another website or a link to a web-page.

In a second option 312, the client may design the Flash file (or other suitable file or format which may be suitable for an interactive application) using his designers by using the web-based interface/system of the present invention. This is done by uploading components of each screen using a web software or interface; and optionally by utilizing a step-by-step “wizard” tool. Once uploaded, these components are connected by the system into an interactive file using the web interface. The final product may be a Flash file, or a file having other structure or format, as described above.

In a third option 313, the client may use template options available on the website for download, by answering questions or using a step-by-step “wizard” module. This route may be easy and fast (e.g., suitable for novice users), and no designers or developers are needed. Files may be generated automatically by the system, and may be played-back on any CMS program or in any web browser. The client may edit, add, remove and/or modify features of these templates from within the SaaS platform, such as colors, text, images, animations, transition effects, or the like.

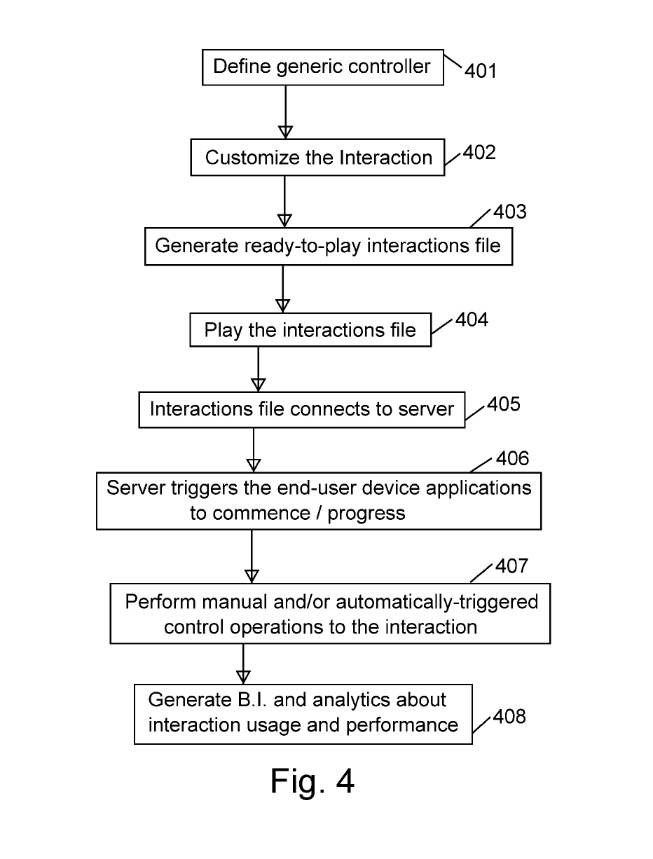

Reference is made to FIG. 4, which is a flow-chart of a method of controlling an interactive application, in accordance with some demonstrative embodiments of the present invention. The system may allow creating of the mobile web-app for smartphones or other devices. For example, the mobile web-app may be an HTML5 framework ready to be used with any interaction. The framework may be lightweight and specifically designed to work in very-low mobile network availability, such as in large sport venues or stadiums or theaters, and does not require a wireless Internet connection (e.g., may utilize low-bandwidth cellular network connection). Once the client selects his interactions, the suitable User Interface (UI) controller will be available for him to edit via the system's “hub” website, while the mobile app in the back remains the same mobile app. This allows for a stable and tested system to be deployed quickly, with the unique user-tailored content.

For each interactive game or app, a basic “white label” or “generic” controller may be defined (box 401, “define generic controller”); for example, for trivia games a controller with answer buttons is defined, and for “tug of war” games a button allowing fast pressing is defined.

In order to edit or modify features, the client may log into the hug site with his username and password, may select his interaction(s), and may go to the “Design” zone or area. In the Design zone, the client may edit the features or the GUI of the mobile controller, for example, change colors and fonts, upload a logo, edit text, add or remove buttons (add or remove trivia questions, or the like), or perform other customization operations (box 402, “customize the interaction”). As with the Flash files describe above, template files or pre-defined template configurations may be available for selection, usage and modification.

This process may be fully customizable depending on the customer's demands or goals. Apps may be connected or inter-related, or may be stand-alone or separated, and may use the same or different URLs. This may be defined by the client once the apps are being customized for him, or automatically via the SaaS platform. Furthermore, it may be possible to change these settings or features even after the apps have been generated and provided. Apps may also be created as native apps, if desired. The creation of the mobile app may be efficient and rapid, and may be done in several days or in a few hours. The client may take part in the design of the Flash file and the controller, or may get a fully-boxed product.

In accordance with the present invention, once the Flash files are ready in the system, the client receives via the Hub site a “closed” Flash file (box 403, “generate ready-to-play interaction file”), that he can play-back on his Digital Signage timeline (via his CMS), just like other files that he currently plays on the timeline (e.g., non-interactive Flash files, movies, or pictures). Alternatively, the client may receive a link or hyperlink or shortcut or other pointer to a file that is hosted in a cloud computing server (e.g., a cloud-based repository of the system's administrator, or of a third-party) or in a “big data” provider, and may launch the file via the link using a web browser.

Once the Flash file is played on the timeline or in the browser (box 404, “play the interaction file”), it automatically connects to the system's servers (e.g., via 3G or 4G or 4G LTE cellular connection, or by other wireless communication links if available) and runs the mobile application in parallel (box 405, “interactions file connects to server”; box 406, “server triggers the end-user device applications to commence/progress”).

The Flash file may be generated in a smart manner such that the Flash file would automatically know to leap or skip or jump to the next stage once it is stopped and started again. For example, in a trivia game, the operation may be: (a) Copy the Flash file to timeline or open in a browser; (b) Play—the pre-game part is played on the main screen and on mobile screens of end-users; (c) Stop—the main screen display stops or pauses, whereas the mobile display of end-users continues to display the pre-game screen or sequence; (d) Play—the next screen automatically plays on the main screen and on the mobile screens; and so forth. The method may include such manual and/or automatically-triggered operations (box 407, “perform manual and/or automatically-triggered control operations to the interaction”). In some embodiments, the system may enable to perform one or more other control operations; such as, a “full restart” of the interactive application, or a fast-forwarding or rewinding of the interactive application to a particular point or chapter or interactions; or a “partial-restart” of a particular interaction or portion of the interactive application (e.g., in a survey application, enabling to command the system to discard all the accumulated survey results and to re-do the survey starting with zero accumulated votes).

In this manner, the operator of the timeline may not need to perform any actions other than Play and Stop (or Pause); and the app itself knows to forward the game automatically to the next suitable point. The final end-users (e.g., a crowd of many users of smartphones and tablets) may “surf” to or may visit a URL (e.g., via a web browser) that can be published pre-game and/or during the game, and from there the operations may run automatically until the Flash file is stopped or ends, as defined by its creator. It is noted that for demonstrative purposes, portions of the discussion herein may relate to visiting a URL in order to access the interactive application; however, other suitable methods may be used, for example, scanning or imaging a QR code or a barcode, utilizing Near Field Communication (NFC), using an audio-based trigger or audible trigger (e.g., similar to the way that the application Shazam identifies a song), by utilizing Apple iBeacon, and/or by utilizing other suitable methods of engagement.

The client may connect to the Hub website to watch real-time statistics regarding the game and/or to later view recorded statistics regarding game usage (box 408, “generate B.I. and analytics about interaction usage and performance”). The client may see such information in his administration panel, using a mobile or desktop web browser. The statistics that are collected and processed may be defined by the system for each app, and may be modified or customized for a specific client or need; and may be utilized, as described above, for automatically generating recommendations, BI insights, best practice suggestions, and/or insights for improvements; which in turn may be immediately (or subsequently) deployed and/or utilized.

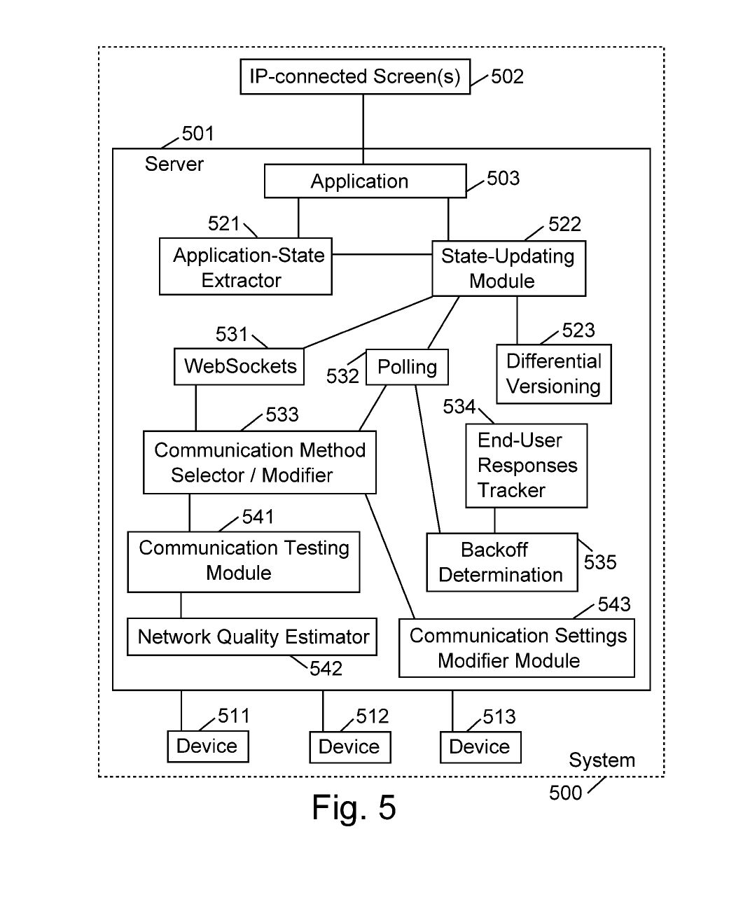

Reference is made to FIG. 5, which is a schematic block-diagram illustration of a system 500 in accordance with some demonstrative embodiments of the present invention. System 500 may demonstrate the efficient utilization of communication resources in order to communicate with a large number (e.g., hundreds, or thousands) of end-user devices; for example, in a sport stadium or arena or other entertainment venue. It is clarified that portions of the discussion herein may relate to WebSockets as a non-limiting example; yet embodiments of the present invention may be utilized with a variety of other communication protocols, standards and/or methods.

In accordance with the present invention, the system's platform may utilize one or more wireless communication network types (e.g., Wi-Fi, Wi-Max, 2G, Edge, 3G, 4G, 4G LTE, or the like). Some embodiments may utilize an algorithm to select a communication protocol or communication network or communication link, based on the connection's quality and/or bandwidth (Websockets, Polling, or other methods). The system's algorithm may even operate on low-quality 3G connection conditions (or other low-bandwidth connection or non-reliable cellular connection) by utilizing network communication optimizations, for example by using the following method.

A server 501 may be wireless connected to an IP-connected screen 502. It is clarified that for demonstrative purposes, portions of the discussion herein (and/or the drawings) may relate to a single IP-connected screen; however, the present invention may comprise, or may operate with, multiple IP-connected screens which may be co-located within a single venue, or which may be distributed across multiple venues or multiple locations (e.g., in the same building, in different buildings or venues, in different cities, in different states or countries or continents). In some embodiments, an IP-screens coordination module may be used in order to ensure that some (or all) of the multiple IP-connected screens show the same (or similar, or related) content, or are updated similarly based on user feedback(s) or based on the progress of the interactive application. In some embodiments, optionally, an interactive application may run on mobile electronic devices of many or multiple end-users, which may be co-located within the same venue or may be distributed across multiple venues; and an aggregation module may aggregate user inputs or user feedbacks from such numerous end-user devices, and may accordingly update the displays on some or all of the IP-connected screen(s).

For example, an application 503 (e.g., a survey application, a trivia questions game application, or the like) may run on the server, and its output may be transferred wirelessly from server 501 to the IP-connected screen 502 for displaying to an audience of numerous end-user devices 511-513. Each end-user device may be, for example, a smartphone, a tablet, a smart-watch, a portable gaming device, a wearable electronic device, an Augmented Reality (AR) device or glasses or helmet, a fitness bracelet or a sports bracelet, and/or other suitable device(s).

An application-state extractor 521 may extract or may copy or may receive the current state of the application 503; and a state-updating module 522 may wirelessly send or transmit or broadcast the current state to end-user devices 511-513. For example, server 501 sends the current game state to the browsers (of the end-user devices 511-513) as soon as it is available. The system's protocol sends minimum data to the clients to preserve bandwidth.

For example, if a trivia game is being played, the questions for a specific game may be downloaded to the client as soon as possible and may be stored and cached on the client's device for the duration of the entire game, using HTML5 local storage and/or cookies. In addition, the system may minimize bandwidth usage by sending to the end-user devices only the parts of the game state that have changed since the last communication with the user devices; for example, a differential versioning sub-system 523 may be used for this purpose, for identifying the differential portions and preparing them for transmission to the end-user devices.

In order to avoid too many connections on a single cellular site, the system's protocol makes sure that in large venues (e.g., a sports stadium or arena) when numerous connections arrive from the same source they may automatically switch to a Polling method (e.g., instead of keeping a connection open via WebSockets). This ensures that a single cellular site does not handle too many concurrent connections. For example, server 501 may comprise a WebSockets-based communication module 531 able to communicate with end-user devices 511-513 via WebSockets protocol; and server 501 may further comprise a Polling-based communication module 532 able to communicate with end-user devices 511-513 via Polling method(s). A communication method selector module 533 may selectively switch between utilizing the WebSockets method and the Polling method. In some embodiments, an end-user responses tracker module 534 may track the responses received from end-user devices 511-513 and/or may track or estimate network congestion, latency, delays, or other communication conditions; and may indicate to the communication method selector module 533 that it would be beneficial or required to switch from WebSockets to Polling, or vice versa. In some embodiments, the end-user responses tracker module 534 may track the number and/or the percentage of end-user devices that communicate, that sent response signals, that acknowledged receiving data, that responded in significant delay (e.g., greater than a pre-defined threshold), or the like; and may compare these parameters to pre-defined threshold values in order to determine whether or not switching the communication method would be required or beneficial, and whether to apply such switching to all end-user devices or to a selected group (or groups) of end-user devices that exhibit certain communication parameters.

Optionally, when using polling communication, exponential and/or pseudo-random backoff techniques may be used, by a backoff determination module 535 which may be associated with the Polling-based communication module 532. For example, when a polling cycle fails, a random or pseudo-random time interval may be selected and used until the next polling cycle begins, in order to maximize the spread of the polling intervals of end-user devices currently playing.

In terms of the mobile end-user devices, the system's platform may be able to operate and run on all HTML5 capable browsers. The end-user points his browser to a particular URL (e.g., the URL may be selected or defined by the venue's owner), at which point the system's HTML5 application may be downloaded to the end-user device. The mobile app may remain cached in the browser on the end-user mobile device. From this point onward, the system's communication algorithm may handle all of the end-user's interactions with the server.

The system's apps may be fully automatic Flash files (or other suitable files), capable of two-way communication with the system's servers. The client who produces the application has to do nothing more than drop the provided Flash file into the digital screen's operation software, i.e. the time-line of the IP-connected screen. Once in the timeline, the client decides when to play the app (e.g., when there is a break or time-out in a sporting event); or the interactive application may run in a fully automatic manner, and may even commence or launch automatically, and/or may stop or pause automatically, based on CMS definitions or based on other parameters or based on pre-defined conditions (and in such cases, the interactive application may begin, run, pause and/or end without requiring any human interaction or human intervention or human control). The client who operates the application may only need to select “Play” to run (to start) the app, and the rest may be performed automatically by the system. The app may automatically proceed to run the Flash on the big IP-connected screen and to start the mobile scenario in parallel on end-user mobile devices. The app also proceeds to automatically move or jump or skip to the next phase (e.g., the next trivia question) once stopped and started again, based on pre-defined rules. The app may thus be easy and transparent to operate, with no particular qualification needed. In some embodiments, in order to run the Flash file by the client (e.g., the owner of the venue), a player capable of running Flash may be required in some implementations, and the player may also need a connection to the Internet).

System 500 may optionally comprise a communication testing module 541 or testing sub-system to optimize or improve performance and efficiency. For example, a test application of the communication testing module 541 may collect network data (e.g., bandwidth information, network latency) related to a large venue prior to conducting a game. By using the test application from multiple mobile devices that are connected to different cellular networks or carriers, a cellular network quality estimator 542 may estimate the cellular network quality (e.g., 3G quality, 4G quality, 4G LTE quality) at a particular venue; and a communication settings modifier module 543 may then optimize the system's protocol and/or communication messages to accommodate that venue if needed; for example, by specifically determining or modifying the polling interval to minimize the client's connection latency, or by modifying or increasing or decreasing the polling interval based on the measured network parameters. Optionally, a testing application may also be available to clients to self-perform tests using their smartphones at their venue, as a stand-alone testing app, or as a test module within another app. System 500 may conduct other tests, for example: functional tests in order to maximize cross platform support and to maximize user experience; and stress and load tests to ensure that the maximum performance and stability of the platform is delivered to the end-users. The results or insights from the testing application or the testing module, may be fed back to the system 500 via a feedback loop, and may be utilized by system 500 in order to modify and/or improve the subsequent utilization of system 500 and/or the subsequent iteration(s) of one or more interactive application(s).

The present invention may include a dedicated testing application that may allow the system to survey the cellular network status (e.g., 3G or 4G or 4G LTE network status) at a venue or location or theater or stadium or other suitable places, which may be indoor and/or outdoor, open or enclosed or partially-enclosed. The application results may help optimize the communication protocol during the actual interaction with multiple users. The test app may check the connectivity (Latency, Connection Losses, and/or other parameters related to Quality of Service, throughput, bandwidth, error rate, or the like) during a real game with real audience in the venue; for example, by opening connections to the system's server and checking the network status. It then submits this data to the system's server, and the data may be used for optimizing the communication protocols accordingly. The invention may utilize a variety of connection options (Web sockets, Polling, or the like), and may select and/or configure the best one(s) or the optimal one(s) according to the actual conditions as tested or monitored in the venue, or may switch from one communication protocol to another based on the gathered data. In addition, during every game, the application may perform optimizations in real-time and changes protocols to provide the best or optimal communication option(s) for the venue.

User data may be stored in a repository on the system's cloud computing server(s), and the use of the stored data may be defined per application in the user agreement and terms, according to the customer's goals as well as in view of privacy laws and practices. This data may be available to the customer for further engagements with their users, depending on privacy laws or other factors. The data may be deleted or modified; data may be used for statistics and analytics available to the customer with regard, for example, to usage of the mobile app by users of mobile devices. Optionally, each mobile app may require its end-user(s) to agree to terms of service via a legal terms screen that may be accessible from the mobile app.

The system's platform may serve multiple types of users, such as: venue owners; publishers; advertisers; designers and developers of mobile apps; consumers or end-users who utilize mobile devices; or the like. For example, the System may be implemented as a B2B2C (business to business to consumer) platform, giving abilities both to business customers and to consumers.

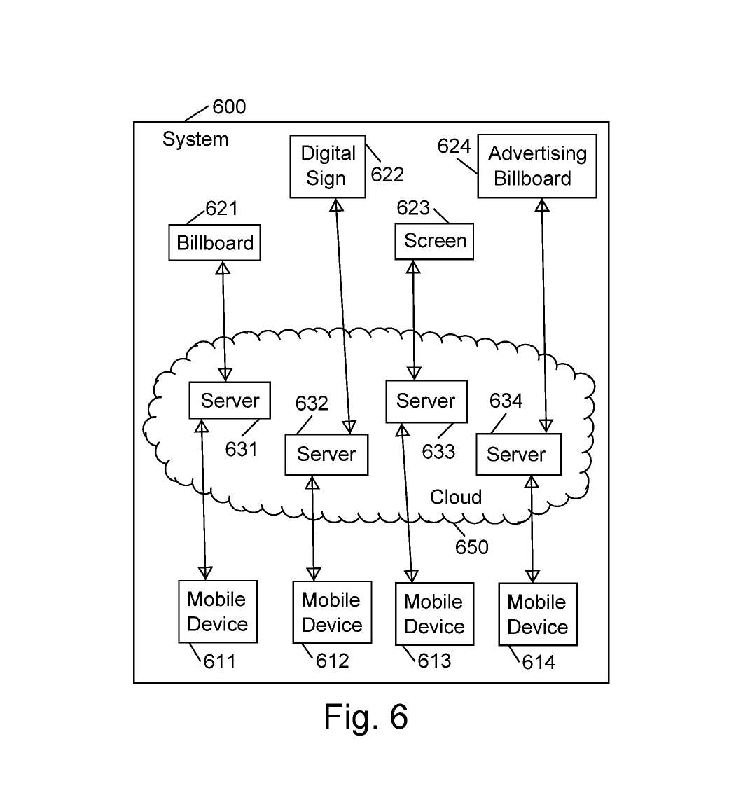

Reference is made to FIG. 6, which is a schematic illustration of a system 600 demonstrating multiple user-case scenarios by a consumer, in accordance with some demonstrative embodiments of the present invention.

The following examples demonstrate utilization of system 600 by a consumer, namely, an end-user utilizing a mobile communication device or other portable communication device. For example, the system's platform enables interaction between his smartphone or tablet (or other mobile device) to a digital sign at a venue or public place or semi-public place.

In a first example, a first end-user Adam may utilize a mobile device 611, and may be standing in front of a large IP-connected digital billboard 621. The end-user Adam may surf on his mobile device 611 to a dedicated URL advertised on the billboard; and downloading or accessing there a web application allowing him to play a real-time game through his on the billboard, such as “Pong” or “Tetris”; and such that the mobile device operates as the user interface, while the large billboard operates as the display unit. If the player wins (e.g., over the computer, or against another local user or remote user), then he may optionally receive a prize or reward (e.g., a coupon, a discount, a promotion, a voucher, a virtual asset, or the like) which may be transmitted to his smartphone (e.g., as a barcode, a QR code, a printable coupon, or the like). The communications between the mobile device 611 and the IP-connected digital billboard 621 may be performed through (or may be facilitated by, or routed through) a server 631 which may be part of a cloud-computing sub-system 650.

In a second example, end-user Bob may be shopping in a shop, and may utilize his mobile device 612 for having an interaction with the shop's digital sign(s) 622. Such interactions may be, for example, surfing from the smartphone to a dedicated URL advertised by the shop, and there downloading or accessing a web-app (or, entering a dedicated native app of the shop); scanning a QR code of a product; signing in to Facebook or other social network, or to the store's account or website if relevant, and then participating in a group purchase which may be limited by time. For example, the customer scans a QR code from a shirt he is interested in; signs in to Facebook, and once done, it is stated on all the digital signs in the store that he is now interested in buying this shirt, and that anyone else joining by scanning the shirt in the next 10 minutes will lower the price by 5% to the entire group. Once the allocated time period elapses, the joining members may purchase the shirt via the application with the accumulated discount. The present invention may thus be used for forming an ad-hoc group of purchasers in a retail store, eliciting multiple shoppers to join together and purchase the same product (e.g., the same shirt) or the same type of product (e.g., a pair of sandals which may be of various types) within a pre-defined time-slot (e.g., ten minutes) in order to achieve a group discount (e.g., a ten percent discount). The communications between the mobile device 612 and the IP-connected digital sign 622 may be performed through (or may be facilitated by, or routed through) a server 632 which may be part of cloud-computing sub-system 650. It is noted that in some embodiments, some or all of the interactions that are described above or herein, need not require manual operation, and/or may be triggered automatically by the system (e.g., based on pre-defined conditions or a flow which may be pre-defined; based on one or more pre-defined parameters which may be checked against threshold values; or the like).

In a third example, during a basketball or other sports game in a sporting venue, all mobile users may be called to surf from their mobile phones to a URL and/or to sign into Facebook or other account or social network account. For example, user Charlie may utilize his mobile device 613 to communicate indirectly with an IP-connected screen 623 of the sporting arena, through an intermediary server 633. Users who surf to the URL and sign in, may participate in live interactive games. Such a game may be a trivia questions game, where questions are presented on the main digital sign in the stadium, and at the same time four possible answer options are automatically loaded to the users' smartphones and are shown to mobile users on their smartphones. Users who answer the question via their smartphone (e.g., answered at all, or answered correctly) may get their Facebook profile picture shown on the main digital sign in the stadium. A winner can be selected from the participants, automatically or manually, in a random or pseudo-random selection process; and the selected user image may be presented on the main screen and a prize may be sent or transmitted to the winner's mobile device, or the user may be summoned to receive a real-life prize or reward.

In a fourth example, passing in the street the user David may notice a big digital advertising billboard 624 presenting a trivia question and displaying a URL address. The user utilizes his smartphone or other mobile device 614, and using a browser he surfs to the URL displayed. The URL page loads within a short time to his smartphone, and displays four options for an answer. The web page also displays an option for sign in with Facebook or other social network. The user may continue and play without signing in, losing the options to win prizes; or he can sign in using Facebook and may accumulate points or rewards. Once signed in, the user is returned to the question screen where he can select an answer. If the user selected an answer prior to signing in, he may get a message confirming that his sign-in details are submitted. Once the user selected an answer, his Facebook photo and name are displayed on the big digital sign, together with other players playing the trivia in front of the sign. After a pre-set time, one of the users playing is selected to be a winner and a discount coupon or other suitable prize may be sent to his mobile phone, and he can redeem it later on, online or offline. The communications between the mobile device 614 and the IP-connected digital advertising billboard 624 may be performed through (or may be facilitated by, or routed through) a server 634 which may be part of cloud-computing sub-system 650.

It is clarified that coupon(s) need not necessarily be generated or provided; and rather, additionally or alternatively, the system may generate and/or may provide a suitable and dynamically-selected call-to-action or a redirection to another activity (e.g., to a download page, to a sing-up form or a subscription form, to a web-site or web-page, to an online form, to an interaction with another application, or the like). Accordingly, any reference herein to a “coupon” or to similar rewards or outcomes, is presented as a non-limiting example; and the present invention may provide or may utilize other suitable calls-to-action, which may be pre-defined or may be dynamically selected from a pool or bank of such outcomes

It is noted that for demonstrative purposes, portions of the discussion herein may relate to visiting a URL in order to access the interactive application; however, other suitable methods may be used, for example, scanning or imaging a QR code or a barcode, utilizing Near Field Communication (NFC), using an audio-based trigger or audible trigger (e.g., similar to the way that the application Shazam identifies a song), by utilizing Apple iBeacon, and/or by utilizing other suitable methods of engagement.

In some embodiments, once the user finishes his interaction he can close his web browser and so exit the game. As long as he does not clean or delete his smartphone browser cache, cookies may remain on his smartphone, enabling a faster load (e.g., shorter loading time; shorter launch time; rapid launch) for any next interaction with the system, as well as faster user identification and/or user authentication. The web application that was loaded to the smartphone may be a framework application that may be the same for any application created by the system's platform (e.g., similar to a library file or a foundation file), thus giving high reliability to any application created using the platform, with known and proven performance, and thereby reducing download time for subsequent applications and/or data.

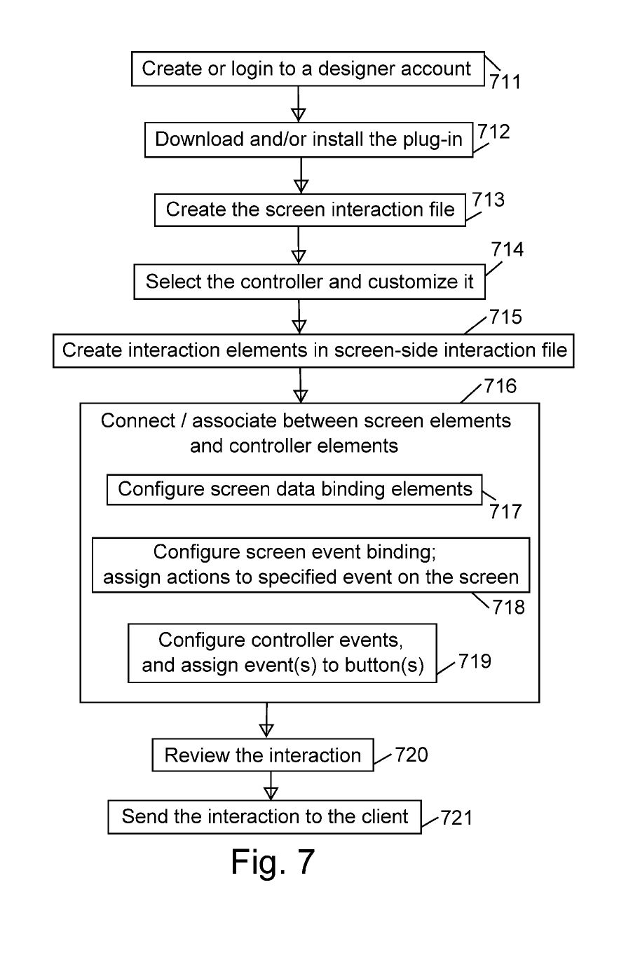

Reference is made to FIG. 7, which is a flow-chart of a method of creating an interaction file, in accordance with some demonstrative embodiments of the present invention. The method may be utilized by designers or developers in order to rapidly create and deploy a new app or application; and may enable any designer working with design software (e.g., Adobe Flash, or After Effects, or a software for designing HTML5 pages or applications) to easily create interactive applications that may be code free and developer free, using data binding and a workflow engine in order to connect between components to interactions and orders and create an interactive experience. Designers may be freelance designers or part of creative teams; all they need is to open an account at the system's website in order to start designing and creating apps. In order to create an interactive app, the designer may perform a set of operations, as described herein. It is noted that FIG. 7 is presented for demonstrative purposes; and a designer may perform only some (and not necessarily all) of the steps or operations that are shown in FIG. 7; and that some or all of the operations shown in FIG. 7 may be performed in other order or sequence, or at different time-points in the design process. Accordingly, the flow-chart of FIG. 7 and its components, are only a non-limiting example of a demonstrative implementation.

The designer may utilize a desktop computer or a laptop computer, in order to surf or browse to the System's web platform and open an account; and to set-up and configure basic account information (“create/login to designer account”). The designer may go to the “Design” section or zone, and may download the system's Flash plug-in (“download/install designer plug-in”), which may install as plugin for Adobe Flash (or for other suitable design software). The designer may proceed to create a Flash file with any creative design desired, without any templates or limitations (“create interaction file/Flash file”).

Once the Flash file is ready, the designer may open or launch or activate the system's plug-in (“activate designer plug-in”), which may feature three main options: (a) Download, for downloading Flash files from the website; (b) Upload, for uploading Flash files to the website; (c) Controller, for creating the mobile phone app from within the Flash file.

Using the “Controller” option, the designer selects one of several options for a controller that fits his design (“select controller from list”), or creates a new controller from a blank template (“create/modify controller”); for example, by using a pre-defined controller, or by using a customized or custom-made or tailored controller.

The pre-defined controller option may be particularly suitable for relatively simple interactive apps created by the designer; such as simple trivia question games, or an interactive game, or a simple commercial. Selectable options may include pre-defined controllers, including for example: four-question trivia controller; two-question trivia controller; poll or survey controller; Most Valuable Player (MBP) selection controller; sport fan selection controller; right and left controls; up and down controls; links to websites, app stores, mobile apps, or other destinations; social media or social networking modules, or social widgets; monetization modules which may be added to the app being created (e.g., in-app purchases; banner advertising); or the like.

The custom-made controller may be used if the designer wants to create the phone's controller from scratch. To do this, the designer may, from within the plug-in menu, create a new blank controller. Onto this controller the designer may drag-and-drop any “control” from a bank or pool of discrete control items or controls, up to a limit pre-defined by the system to retain usability of the app (“customize controller”). Such controller(s) may include, for example: question button; answer button; up arrow button; down arrow button; accelerometer controller; sound controller; general buttons; and so on.

The controller may be based on pre-designed interactions created by the system that are available via the plugin. The system looks at the controller as if it was a game console controller, such that, for example, four buttons may control any type of game; and all games are played using a pre-defined set of physical controls. The system defines a set of “controls”, that are available to the designer of the mobile app. The designer fits his interaction with the relevant control(s) out of the bank or pool of available controls. These predefined controls may be based on the smartphone abilities, and may include, for example: use of touch screen for action buttons such as “up”, “down”, “jump” or the like; use of the smartphone accelerometer for related actions, such as throwing a ball to the basket based on the movement of the smartphone; use of GPS or other location-finding mechanisms (e.g., cellular triangulation, Wi-Fi data) for location based controls or for geo-spatial related controls; use of camera for camera based controls (e.g., the camera capturing hand gestures or face gestures of the user); use of microphone and speaker for sound related controls (e.g., with a speech-to-text converter to allow voice control); or the like.

The designer may create the content and the interactions of the game or application, and may bind them to control elements or buttons or other UI components (“create content and interactions, and bind them to UI components”). For example, the designer may create the creative elements and/or interactions and/or content and/or the graphics and text and audio for the big digital screen (“create the interaction elements”), and then connect each element(s) to the selected controls via the plug-in or on the website itself (“connect/associate between creative elements and controller elements”). It is noted that the created content may comprise animation(s) (e.g., Flash animation), but need not necessarily comprise such animation(s); and the created content may comprise video file(s) (e.g., “pure” video files). It is clarified that the term “animation” as used herein, may comprise all suitable types of animating objects, and may further comprise a video clip or file, an audio/video clip or file, or other video-based clip or file; and need not necessarily comprise Flash-based animation of objects.

Once the controller is defined with buttons, the designer submits the buttons and connects them to the Flash entities that he designed. For example, the designer may first create a Flash file in which an animated character has to evade cars coming towards it. The designer may design this; first he may create a layer and create the person in it; then he may associate the person with the behavior, such as moving from the center of the screen to the right or left. Once this animation is finished, the designer may create in another layer the car and its animated behavior, such as moving from the top of the screen to the bottom of the screen. Once all the animation is finished, the designer may open the plug-in menu. From the menu he may select “New controller” and save it with a name. Then, in a dedicated visual window that opens, the designer may have the empty canvas of the controller. He may then drag a “left and right” button from the buttons bank, and a “jump” button as well. He now has a controller with three buttons (left, right, jump). In the next stage, the designer may select the animated person in the Flash interface; and using drag-and-drop or menu options he may assign the three controls to the animated image (“assign interaction buttons to graphical elements”). Once done, the designer may design the look-and-feel or other features of the controller, such as, change its colors, text, add images or logo, and so on. Once defined, the designer may save the Flash file and upload it using “Upload” to the system's platform or repository or cloud-based repository (“save/upload file to designer's folder”). Once in the platform, the file automatically computes or is converted into an interactive application and is ready to use.

The designer may now see and review his uploaded file in his account (“review file”). He may further re-edit or modify some attributes or characteristics of the controller(s) and the Flash file from within the web interface (“modify/re-edit attributes”). Such editing may change the controller's colors, texts and some functionality, such as the number of questions in a trivia game, or different time definitions for starting or stopping an interaction or a stage in the app.

The designer may also upload or send the created file straight into a client's account on the cloud-based platform (“send/upload file to client's folder”), so the client will receive the finalized file and/or review it and/or test it and/or use it. This way a designer may be completely independent in creating interactive applications for digital screens. Everything is done visually, using visual controls and simple commands No code entry may be needed in the process, and no coding skills or knowledge may be required. The designer creates both the Flash file for the big screen and the HTML5 application for the smartphone.

In some embodiments of the present invention, a method may comprise the following steps, or some of them; in the following order or in other suitable order or sequence; as demonstrated in the flow-chart of FIG. 7: box 711, create or login to a designer account; box 712, download and/or install the plug-in; box 713, create the screen interaction file; box 714, select the controller (e.g., via the plug-in) and customize it; box 715, create interaction elements in screen-side interaction file; box 716, connect/associate between screen elements and controller elements; box 717, configure screen data binding elements (e.g., connect a leader-board UI element on the screen to a data source on the server); box 718, configure screen event binding (e.g., assign actions to specified event on the screen; such as, make a goal-keeper jump when an event occurs); box 719, configure controller events, and assign event(s) to button(s) (e.g., when the user swipes left, send the goal-keeper “jump” event with “left” as an event argument or event parameter); box 720, review interaction (e.g., run the interaction and test it); box 721, send the interaction to the client. For demonstrative purposes, the steps of boxes 717-719 are shown as possible sub-steps of box 716; however, other sub-steps may be used, or some sub-steps may be utilized in combination or in other order. Other suitable steps may be performed, at other suitable order or sequence. It is clarified that portions of the discussion which may refer to “screen elements” or “screen interactions” or “screen-side elements” or “screen-side interactions” may comprise, for example, elements or interactions that are intended to run or to be displayed on the IP-connected screen; whereas the terms “mobile elements” or “mobile interactions” or “mobile-side elements” or “mobile-side interactions” may comprise, for example, elements or interactions that are intended to run or to be displayed on the mobile end-user device. In some embodiments, the system may enable a connection or a communication channel that enables mobile-side interactions to affect screen-side interactions or displays, and/or vice versa.

Video based interactions may be supported by the system. For example, the system may further allow the designer to primarily use video files with an added interactive layer (e.g., based on Flash) on top of them. In this way, the designer is designing the interaction by creating video files using Adobe After Effects or similar products; and once the video part is ready, it will be imported into a Flash container, allowing two options for adding interactions on the video: (a) Use a script or a suitable module in order to select a second video component based on the interaction and then run it over the original video layer. For example, the designer may have a video background and four more videos showing the logos of different companies. In this interaction the audience selects one company out of the four. Once the selection is made using the smartphones, the system will run the relevant logo above the background. In this case, the Flash is only a container and muscle to run videos. (b) Use a video background, with the interactive elements being animated Flash elements. For example, for a poll or survey, the background of the screen may be designed with video, while the interactive bars showing the results may be Flash animations.

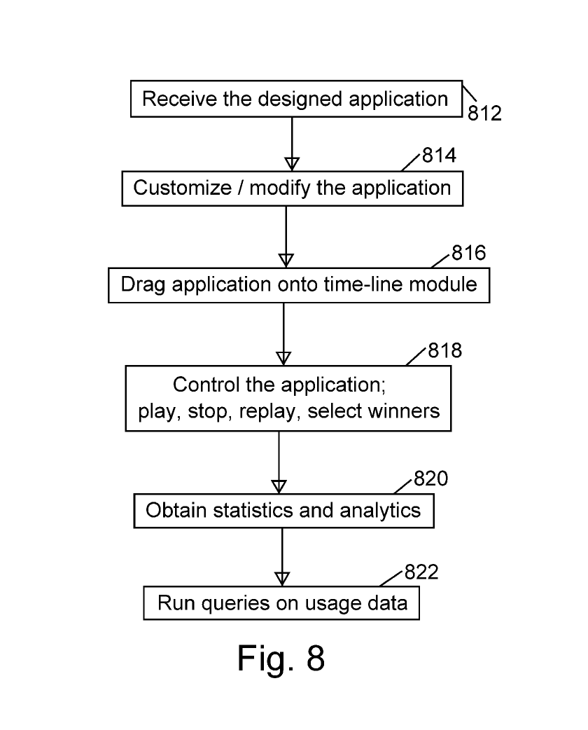

Reference is made to FIG. 8, which is a flow-chart of a method of managing an interaction file, in accordance with some demonstrative embodiments of the present invention. The method may allow a Campaign Manager to perform various operations, and particularly Design, Management, and Monitoring Statistics.

For example, the campaign manager receives the designed application from the designer, directly or via the web interface (box 812, “receive the designed application”). The designer may upload it to the manager's account, or the manager may download it from the designers account, all via the system's website. The campaign manager may be any client of the interactive app created by the designer, who is in charge of running it on the digital sign it was designed for.

The campaign manager may to have full control of the designed app, to modify the design of the controller app, to manage the content and to get custom statistics regarding the app's performance and users. The campaign manager can see all the apps currently in his account via a navigation tree, in a “Windows” style file interface. Once he selects an app, this app will be available for editing and viewing. The categories available for each app may include, for example: Design; Manage; Statistics.

In the Design module for campaign managers, the campaign manager may further design and modify the app (or its features) after the designer had already created it (box 814, “customize/modify the application”). This is useful for altering an experience based on an application that has been previously created. An example may be a trivia game run during one season in a sport venue, which can be easily re-designed (customized, edited, modified) for the next season to have a new look, or to have a different number of questions, or the like. In some embodiments, this may provide to the designer or to the user of the application, the ability to modify or edit the HTML5 content, and/or the text content of the main screen of the application (e.g., if the application is a Flash file), in order to preserve simplicity and ease-of-use. If the digital-screen application is based on HTML5, greater editing abilities may be provided to the campaign manager by the SaaS platform without needing a designer in the process.

From the “Design” area of the System's platform website, the manager may efficiently, for example: edit the texts appearing in the mobile controller app; edit the texts appearing in the Flash file running on the digital sign; edit attributes of the app, such as the number of questions in a trivia game; edit the mobile controller app's design—change colors, line types and thickness, change fonts, add images and change them; assign coupons, prizes, or the like. These operations may be performed by using a visual based management interface allowing selections from drop menus, color pickers and text edit fields. No coding may be required, and the process may be easy and friendly. Once done, the new design can be saved as a new app, thus not changing the previous app it is based on.

In the Manage module for campaign managers, the campaign manager may drag-and-drop the application onto a time-line module of the IP-connected digital screen (box 816, “drag application onto time-line module”); and may control the app or apps, once it is on the timeline of the CMS software (box 818, “control the application; play, stop, replay, select winners”). Depending on the app, options may include, for example: play the flash file on the digital sign (thus playing the mobile app as well); stop the Flash file and app; replay them; select winners from the users of the app (e.g., from the users who are currently playing, or from the users who have played in the last 60 seconds); perform other operations relevant to the specific app currently controlled.

In some implementations, apps may also be fully automatic, with no management available or needed for them. In case of a fully automatic app, the manager or the person managing the CMS software of the digital sign may receive the ready app (e.g., by downloading it from the SaaS platform, or by email from the designer). Once he has the app, he can drop it on the CMS timeline, as with any multimedia file running on the digital board. The automatic app is then run at the set time on the timeline. Once it is running, the app may automatically perform the predefined set of actions it was designed to do, to interact with the system's servers, and with the mobile web-app. Such automatic process may include, for example: (1) using the System's plugin, a designer designs an automatic Flash trivia game; (2) once the Flash for the main screen is ready, the designer connects controls and by this creates the mobile controller app; (3) the designer uploads the app to the client's System account, and a link is sent to the client; (4) the client, from the management section, can now edit the app, and change the design of the HTML parts from the design sections, and optionally may modify or set one or more triggers or conditions for automatic behavior of the interactive application (e.g., may define that an event in the application would automatically being at a certain time, or when a certain condition holds true, or at pre-defined time intervals, or when one or more parameters are matched with pre-defined threshold values); once the client is satisfied, he can download the Flash file to his CMS computer and drop it on the timeline where he wants it to play; (5) at the right instance, the Flash file will start running will automatically connect and run the related services, for example: (a) the mobile web app may be updated according to the Flash file—as an example, in a trivia game when the first question appears on the large digital sign, the mobile phone will automatically load the question's answer options; once the question has ended on the main screen, the mobile phone will present the post question screen, and so forth; (b) statistics and analytics may be updated and presented in the statistics section of the SaaS platform; (c) for Facebook connected users, profile photos may be displayed on the main digital sign at the right moment; and in some embodiments, this feature may require advance consent of the user of the mobile device; (d) winner(s) may be selected and displayed on the main screen; a coupon or other prize may be sent to winners' phones. Such actions may depend on the app design and may vary accordingly. Any app may be designed as automatic, semi-automatic, or fully manual, needing the actions of the manager via the “Manage” area to perform.

In the Statistics module for campaign managers, the campaign manager may obtain and view statistics and analytics (box 820, “obtain statistics and analytics”) regarding any of the apps he has in the system. The information is defined by the manager, and may include, depending on the app, information such as: users using the system (e.g., surfing to the web app); users at any of the app's pages at any given moment (e.g., users now in the “terms” section, users answering the questions, users posting questions, or the like, depending on the app's pages); users connected through social network(s); real-time data regarding users behavior; real time data regarding coupons, links or prizes; information publicly available on the connected user's social profile (subject to law and terms or privacy policy of each app); or the like. The statistics may be available during the app operation as live real-time dynamically-updating data; and once the app has been stopped or terminated, as post event statistics and analytics found at the statistics section, as a logbook or other history file or section. The user may select to delete this information and to alter it depending on his demands and each app's abilities; customized statistics or queries may be defined and run, in real time or in retrospect regarding past activity.

In some embodiments, the system may provide real-time monitoring and alerts and/or notifications, which may optionally be transmitted or conveyed or pushed to one or more specific users (e.g., system administrator, or campaign manager), and which may optionally be pushed wirelessly to a mobile electronic device (e.g., smartphone, tablet) of such user(s), or may be notified via one or more means (e.g., email, SMS messages, instant messaging, audio messages, or the like). For example, the system may be configured to generate and to “push” real-time usage statistics from a particular venue, or from multiple venues (e.g., worldwide), to a particular user or users, in a continuous reporting manner or at pre-defined time intervals (e.g., every 15 seconds, every 60 seconds), or at reporting intervals that are triggered by pre-defined conditions or threshold values (e.g., send-out a reporting notification or alert, if an error that is pre-defined as “critical” is detected; or, send-out a reporting notification or alert, if more than 3 errors (critical and/or non-critical) accumulated, or occurred within a pre-defined time period).

In some embodiments, the manager may run queries on the usage data, or may request to create graphs or charts or reports that are representing the data or that are based on the data (box 822, “run queries on usage data”), in order to mine the data and/or identify insights or conclusions. The system may generate reports which may assist the manager to identify and/or understand performance issues, communication problems or issues, Return on Investment (ROI), performance of A-B testing, generation of “best practice” insights or recommendations or suggestions, generation of BI insights, or the like. In some embodiments, some or all of the usage data and/or the performance data, that is being collected and/or monitored and/or tracked and/or analyzed and/or stored, may be partially-anonymized or may be entirely-anonymized (e.g., may be stripped of data-components that allow identification of user identity); thereby preserving or enhancing the privacy of users of the interactive application.

In a demonstrative example, the manager may request to view how many users of mobile devices have answered each one of four trivia questions that were included in an application; and the results may be, for example, 500 users answered the first question, then 480 users answered the second question, then 470 users answered the third question, and then 210 users answered the fourth question; thereby indicating that four trivia questions are too many questions, and that three or two trivia questions may suffice before the users lose interest and quit the game. Alternatively, it may indicate that the fourth question might have been too difficult or unclear. Other insights may be deduced or observed.

The system may utilize a smartphone or other handheld device or portable electronic device (e.g., tablet, smart-watch, Augmented Reality (AR) device or glasses or helmet, portable gaming device, or the like) to become or to operate as the controller of the experience from the end-user point-of-view. The system's technology allows the controller to be either a native app or a web application. Being a web application, the system's technology creates a lightweight web application loaded to the handheld devices even at poor or low-bandwidth (e.g., 3G) connectivity as in stadiums or theaters or other closed venues or indoor locations. The system's controller may be a lightweight HTML5 framework, thus sturdy and proven, and it may run behind any application built using the system. This may be an important asset as it may not matter which application is running, such as a car race or a trivia game, and where it is running, and the application behind it on the smartphone or tablet may remain the same. This feature may have important implications as the framework is tested, stable and proven, so there is no need to check each application built using the system: any newly-created application would immediately run on a mature and proven framework or foundation, rather than being built from scratch or from the ground up each time for a certain purpose.

The system's platform may be implemented as a Software as a Service solution, and the first cloud based, full SaaS solution for the creation, management, distribution and measurement of interactions between handheld connected devices such as smartphone or tablets to digital screens connected to the Internet. The system allows the rapid and efficient creation, from within existing software and from the web itself, of interactive apps, without the need for programmers or coders or developers. The system's solution takes a complicated, long and expensive process and turns it into a simple, easy to use product. The system's cloud may also operate as a comprehensive data hub, storing and analyzing data regarding interactive activities, allowing to better understand, analyze and learn best practices regarding what is working and what is not. On top, the system may also create and support a community of users sharing ideas, know-how and knowledge regarding interactions between mobile devices to screens. The system may provide a framework allowing the user to create almost any application, without templates for the big screen and with only operational templates for the controller. This way the system makes the developers unnecessary, allowing for a much simple and fast creation time.

In some embodiments of the present invention, the creator of the interactive Flash file, usually a designer utilizing the Plugin from within his Flash software, or a designer using the web interface for HTML5 applications, may build the interaction with a simple drag and drop logic. This may be performed by providing him with a plug-in, extension, add-on, or a menu added to his Flash software or other suitable software or web-based application. Once the designer finishes creating the Flash file (or the HTML-5 application), he may use the plugin menu to make this Flash interactive.

For example, the designer opens a visual menu with components that he can “connect” to the Flash file that he created. This menu may create the HTML5 controller that later loads to the end user's smartphone. in this menu, the designer picks the way that he wants the user to interact with the screen. For example, if the Flash file features a car race, then the designer may pick relevant controllers that control a race car in a video game—such as arrows for moving left or right, a button for acceleration and optionally a button for slowing down. He then drags these components onto the stage where the Flash elements are, and by this defines them as connected to each element, based on his drag and drop; for example, he may drag a “right” arrow onto the car, thus connecting the car's right movement to this control, via a script or other suitable means.

The designer may then apply additional design to the controller app itself; now he has the controller defined and he can add or set or define colors, fonts and texts and other features or parameters. At the end of this process, there may be two outcomes: (a) an interactive Flash file as described; (b) an HTML5 controller to control it. Both files are uploaded to the system's repository or cloud server, where they are stored and later executed (e.g., dragged onto a timeline for playback), and further definitions or modifications may be added to them, such as native application or web-app via the website interface. The HTML5 file of the controller may be further edited online once it has been uploaded from the design menu of the website.

The present invention may allow the Flash/App Designer to assign classes to different objects on the stage (Movie Clip). By selectively assigning these classes, he may make the objects receive events from the connected user phones (or other end-user devices). The assignment of classes to object(s) can be done via a special graphical plugin that the present invention may add to the designer's development environment. On the phone side, the invention may allow the designer to add components (Buttons, Images, Combo Boxes, or the like) from his Flash IDE or from a website. He can then attach actions to every one of the components that are received on the Flash side (For example: Attaching a click event to a button; when the user clicks on the button the flash components that were listening to the event will receive it and act accordingly).

In addition, the present invention may allow the designer or developer to perform data analysis on the user actions; for example, obtain data about all the users who clicked on a certain button, or get the number of people who clicked the button, or the like. This may allow the Flash designer to produce graphs, lists of users (with pictures), or other insights.

The present invention further enables automatically remote controlling, operating and monitoring an interactive experience among multiple mobile devices and IP-connected digital screens or displays. The present invention facilitates automatic and/or manual interactions between electronic devices or mobile devices (such as mobile phones, cellular phones, smartphones, tablets, laptop computers, netbook computers, notebook computers, smart-watch devices, wearable devices, or the like) to Internet Protocol (IP) connected or IP-enabled or IP-supporting digital signs (or digital screens, or digital displays), over a wireless communication network (e.g., via the Internet, a Wi-Fi network, a Wi-Max network, cellular network, 3G network, 3.5G network, 4G network, 4G LTE network, a combination of networks, or the like). The present invention may provide a computerized communication and control flow between mobile devices and an IP-connected digital screen via an intermediary server, enabling two-way automatic interactive communications based on pre-defined logics and end-user actions.

The present invention may enable to control and/or monitor these interactions, in an automated, efficient way. Controlling the interaction between the mobile device and the digital sign may involve triggering automatic actions between several files and devices, in a way that an action initiated in one interface or file, initiates or triggers or causes a “chain reaction” between the mobile device user (the end user), the digital screen running the interactive file (e.g., from the browser via a cloud service, and/or from a local file running in the time-line), and the administrator (“admin”) dashboard system or control panel, showing the interaction's state, statistics and analytics, and allowing for further manual operation, where applicable.

Applicants have realized that current mobile-to-screen interaction requires utilization of an “admin panel” for the operation of the interaction. Such “admin panel” or “admin dashboard” may allow the operator of the interaction to start the interaction, stop it, pause it, and reset it. In accordance with the present invention, an “admin panel” or “admin dashboard” may allow the administrator to set or define or select automatic triggers for the operation described, based on time, user actions, or other conditions. For example, any interaction through the admin panel may be associated with a timeline that schedules the interaction. This interaction may be, for example, a trivia game for sport venues. In this case, a human operator has to use the timeline software to manually open the trivia questions shown both on the users' smartphones and on the arena's IP-connected digital screen. The administrator may then close the question, allow to select winners, and may perform other operations. Some of these operations may be set ahead to be automatically scheduled, using the timeline software interface and by defining triggers or by issuing API calls.

Applicants have realized that this method of operation may be inappropriate for live events such as sport events, conferences, or other events where real-time response or rapid is critical. However, for the advertisement industry, this way of operating an interactive experience is non-relevant, as interactions between mobile devices and digital IP-connected displays or signs are meant to run for several days or weeks, without the need for human intervention, and particular without the need for real-time or rapid response. For example, an interactive digital signage campaign by an advertising agency may consist of a digital sign calling passer-by audience to connect to the sign, perform an action using a mobile device, and then see the resulting reaction on the digital screen. Such an interaction may be standing in front of a digital sign, connecting to the sign using the smartphone, selecting an item desired for a discount from an offer of three options, and then receiving a coupon. In this kind of interactions, everything has to be running automatically, between the mobile device, the server and the digital sign.

The present invention provides a fully automatic operation, enabling the above example to run automatically and without delays, and enabling real-time two-way communications. This includes creating the communication between the mobile device to the server, between the server to the mobile device, and vice versa. The present invention further provides the ability to automatically run mobile to screen interaction indefinitely, without the need for human operation from the initial starting point where the interaction was first run or started operation.

The present invention may be implemented as a cloud based SaaS (Software as a Service) platform allowing the operation of interactive applications allowing real-time two-way interaction between mobile devices (such as smartphones, tablets, smart-watches, wearable devices) with digital IP connected signs, such as advertising billboards of any size, computer screens, smart TVs, and any IP-connected screen, without the need for human operator in the loop.

The System's platform may operate on one or more network types (e.g., Wi-Fi, Wi-Max, 2G, 3G, 4G, 4G LTE). Some embodiments may use an algorithm to select a communication protocol based on the connection's quality and/or bandwidth (Web sockets, Polling, or other methods). The System's algorithm may even operate on low-quality 3G connection conditions by utilizing network communication optimizations:

In a demonstrative implementation, the server sends current game-state to the client's browser, as soon as it is available. The system's protocol sends minimum data to the client to preserve bandwidth. For example, if a trivia game is being played, the questions for a specific game may be downloaded to the client as soon as possible; and may be stored and cached on the client's device for the duration of the entire game, using HTML5 local storage and/or cookies. In addition, the system may minimize bandwidth usage by sending to the user devices only the parts of the game-state that have changed since the last communication with the user devices. A differential versioning system may be used to achieve this goal.

In order to avoid excessive or too many connections on a single cellular site, the system's communication protocol may ensure that in large venues, when numerous connections (e.g., dozens, or hundreds, or thousands) arrive from the same source, they may automatically switch to a polling method (e.g., instead of keeping a connection open via web sockets). This ensures that a single cellular site does not handle too many concurrent connections, and may thus prevent or mitigate communication problems or unavailability of cellular service due to over-crowded usage of a cellular site or cellular cell.

When using polling, exponential back-off strategies may be utilized. For example, when a polling cycle fails, a pseudo-random back-off time interval may be selected and introduced until the next polling cycle, in order to maximize the spread of the polling intervals of client devices currently playing.

In terms of the mobile devices and end-user client devices, the system's platform may work on all HTML5 capable browsers. For example, the end-user points his browser to a URL (e.g., the URL chosen by the venue's owner or operator), at which point the system HTML5 application(s) may be downloaded to the end-user device. Optionally, the application may remain cached in the browser cache on the mobile device. From this point on, the system's communication algorithm may handle all of the client's interaction with the server.

The System's application(s) may be fully automatic Flash/HTML5 files, capable of two-way communication with the system's servers. The entity that produces the application may simply drop the provided Flash/HTML5 file into the digital screen's operation software, i.e. the time-line module associated with the IP-connected screen, or to run it from the browser, in case of an HTML5 application. Once initially run, the application would run the Flash/HTML5 on the screen and also start the mobile-devices scenario in parallel. The application also automatically moves to the next phase (i.e., the next question) once stopped and started again, based on pre-defined rules or criteria, or based on pre-defined conditions that are met or that become true (e.g., if a pre-defined number of mobile devices already submitted an answer to a trivia question). The application may thus be efficient and easy and transparent to operate, with no particular qualification needed. In some implementations, in order to run the Flash/HTML5 files, a player capable of running Flash/HTML5 may be required in some systems, and the player may also need a connection to the Internet (which may be via cellular network, even at low or ultra-low bandwidth).

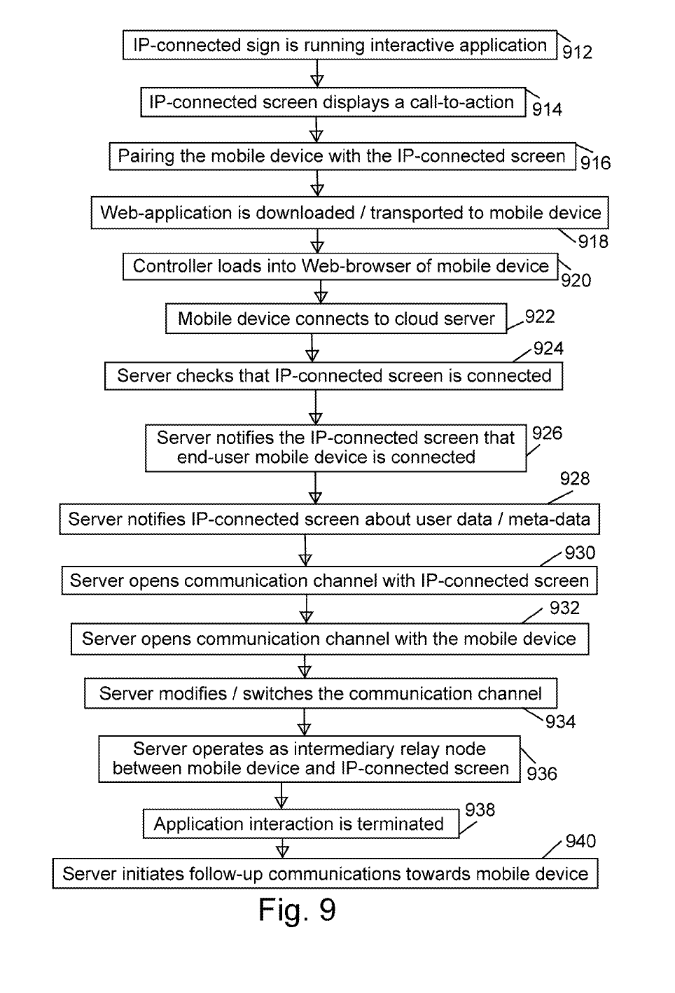

Reference is made to FIG. 9, which is a schematic flow-chart of a method of enabling communication and facilitating interactions between an end-user mobile device and an IP-connected screen, in accordance with some demonstrative embodiments of the present invention. In a demonstrative user flow described herein, the user may be the end-user, namely, the guest or audience-member who holds his own mobile device (e.g., smartphone, tablet, smart-watch, wearable electronic device) and interacts through it with an IP-connected digital sign or IP-connected digital display unit.

For example, the end-user arrives in front of (or near) the digital sign which is running the described file or application (box 912, “IP-connected sign is running an interactive application”), either locally from a time-line module, or from the Web using any web browser. The file may be a Flash file running on the time-line module, or a Flash file running in the browser via the cloud (e.g., downloaded to the browser), or an HTML5 file running in the browser (e.g., downloaded to the browser), or any other suitable file allowing this kind of interaction to take place.

The file has been put in the time-line module and run, or run from the browser, by the owner or operator of the digital sign (e.g., the owner or operator of a venue or arena or store), at a time-point prior to the interaction. The sign-owner has run the file using his time-line software, or using the browser (if it runs via the cloud). Once running, no further intervention or operation is needed from the venue owner, and the file runs indefinitely until stopped again, by stopping it on the timeline via the dedicated software for local running files, or by closing the browser window if the file is running via the cloud.

At this time, when the screen-side interactive file is already running on the screen, an end-user is standing in front of the screen with his mobile device ready for operation. The end-user may look at the digital sign, where the running content may create or may display a “call to action”, asking the end-user to connect to (or join) the screen or the experience presented thereon (box 914, “IP-connected screen displays a call-to-action”).

Connecting or pairing or associating between the mobile device and the digital sign may be performed (box 916, “pairing the mobile device with the IP-connected sign”); for example, using Near Field Communication (NFC) tags on the screen while the user utilizes his mobile device's NFC ability to connect; by reading or scanning a QR code or two-dimensional barcode that appears on the screen as part of the interaction shown; by Bluetooth connectivity; by manually typing or entering a URL address in the mobile device's browser; or by other suitable method allowing to point a mobile device to a web address.

Once the end-user performs one of the above options, he reaches a web-app that will download from a server (that is associated with the link or QR code) to his browser on his end-user device (box 918, “web-application is wirelessly downloaded/transported to mobile device”). It is noted that even though the term “download” is used, this may not necessarily require the end-user to “install” a software application or to actively consent to such installation; but rather, such “download” may comprise, for example, the wireless transport of data packets (e.g., HTML5 data, or Flash file) from the server to the end-user mobile device, as part of a process in which a Web browser of the mobile device accesses a web-page or hyperlink.

At this time, the “controller” (namely, the web-app) loads in the browser of the end-user device (box 920, “controller loads into Web-browser of mobile device”), displaying to the end-user the mobile part of the interaction (the interaction spanning two parts: a part operated on the mobile device, and a part displayed on the IP-connected screen). This content depends on the interaction; for example, in a trivia game, a controller consisting of buttons allowing to select the right answer will be displayed on the mobile device; if it is a darts game then the user will have an arrow displayed on his mobile device; and so on.

Once the user initiates the connection using any of the above methods, the end-user device is connected to the cloud server (box 922, “mobile device connects to cloud server”), which in turn checks whether an IP-connected screen is actually connected to the cloud server (box 924, “server checks/verifies that IP-connected screen is connected to server”), based on the URL that the end-user is trying to access. If the server does not find the relevant IP-connected screen to be currently connected to the server, then an error message is sent to the end-user device.

If the server finds the relevant IP-connected screen to be indeed connected to the server, then the server may notify the IP-connected screen that an end-user is connected (box 926, “server notifies the IP-connected screen that end-user mobile device is connected”), by indicating the file running on the mobile device. The server may further notify the IP-connected screen regarding the end-user's data or meta-data, as defined in the experience; for example, Facebook (or other social network) name and photo, Twitter (or other blogging or micro-blogging) name and photo, any other relevant details defined in the application, user ID (e.g., phone number), end-user device type, and/or other user data and/or other meta-data about the interaction (box 928, “server notifies the IP-connected screen about user data/meta-data”).

The server may then open a two-way (full duplex) communication channel between the IP-connected screen (e.g., the file which is running on the IP-connected screen), to the server and back (box 930, “server opens first communication channel with IP-connected screen”); and the server opens another two-way (full duplex) communication channel between the mobile end-user device to the server and back (box 932, “server opens first communication channel with the mobile device). The two communication channels may utilize different communication protocols or methods or standards. For example, the first communication channel may be reliable and/or high-bandwidth; whereas the second communication channel may be less-reliable and/or low-bandwidth.

For example, the second communication channel may be based on one or more suitable technologies, depending on the demand (or lack of demand) for real-time action and/or rapid response between the mobile device application to the screen file. For example, interactions requiring rapid response may include games asking the user to perform an action on his device that mirrors immediately on the screen; such as a virtual soccer game in which the user is “virtually kicking a soccer-ball” by using the mobile device accelerometer, a ball that is then shown “kicked” on the big IP-connected screen. In contrast, an interaction that may not demand such fast response may be a trivia questions game or a poll or survey, where the end-user selects an answer that is then reflected on the IP-connected screen, such that a small delay (e.g., one second, two seconds) is not significant to the user's experience and does not adversely affect the result of the interaction. The communication channel may utilize web-sockets, polling or REST, depending on the need. Optionally, the second communication channel may be modified by the server, or may be switched from a first communication protocol or method to a second communication protocol or method (box 934, “server modifies/fine-tunes/switches the second communication channel”), based on network conditions and/or network parameters, and taking into account the type of interactions that the application requires (real-time or time-critical interactions that cannot tolerate legacy or delay, or non-time-critical interactions that can tolerate slight delay of a few seconds).

At this time, the end-user has a web-app loaded in his end-user mobile device, allowing him to perform real-time interaction with the content running and displayed on the IP-connected digital sign. Actions performed by the end-user on his mobile phone, will result in real-time or near-real-time (e.g., depending on the technology used) results and effects on the IP-connected screen.

For example, the IP-connected screen may present a poll question with two options (two possible answers), represented by interactive bars. On his mobile device, the end-user is presented with two buttons to select one of the two options. Once selected on the mobile device, the command is sent from the mobile device to the server running in the cloud, and from the cloud to the IP-connected digital sign, causing a reaction such as movement of the bars and displaying the updated percentage, and optionally showing on the IP-connected screen the user's photo and name (or other details).

In accordance with some embodiments of the present invention, once the data from the user's mobile device is received by the server, the server may send information or commands to the user's app. Such commands may be, for example, switching the end-user's web-app to a new web-page (such as post-voting page), sending to the end-user a coupon or promotion or a file to download, or the like. The communication may continue back-and-forth between the server and the web-app on the end-user device, and between the server and the IP-connected digital screen, resulting in a dialogue created between the user and the screen, while the server acts as “middle-man” or as intermediary device in such communication system (box 936, “server operates as intermediary relay node, between the mobile device and the IP-connected screen”).

In some embodiments of the present invention, the communication session may be terminated, for example, by the end-user closing the web-app on his mobile device; and/or by the server closing the interaction as a result of the flow of the interaction (e.g., the game reached its end, or a pre-defined time that was allocated to the game has elapsed) or its design or rules (box 938, “application interaction is terminated”). In some implementations, the server may now store user data (e.g., Facebook username, Twitter username, email address, or other user-data depending on the interaction performed by the user; such as, if the user signed-in to these services from within the web-app), and further follow-up or tacked-on communication(s) between the server and the end-user device may still take place or may continue; such as, for example, the server may now send to the end-user device additional content, a promotion or coupon, an advertisement, a file, a video clip, an animation clip, or the like, depending on the specific interaction (box 940, “server initiates follow-up communications towards the mobile device”).

Although portions of the discussion herein may relate to manual or semi-manual operations, it is clarified that these are non-limiting examples; and the present invention may comprise fully-automated and/or fully-automatic processes and systems, able to operate continuously without manual intervention and without human intervention; and optionally allowing or enabling manual operation only for specific pre-defined events and/or on-demand.

It is clarified that the terms “animation” or “video”, as used herein, may comprise any suitable type or format or structure of animation, moving images, scripted animation, non-scripted animation, a video clip, an audio/video clip, a streaming video, a live video feed, a video file, a video file encapsulated within an object or augmented with additional layers (e.g., text layers, graphic layers), and/or other suitable types of animated or video-based items or clips or files or structures.

Some embodiments of the present invention may utilize a step-by-step “wizard” module which may enable (or may assist) a designer to create an interactive application for interactions among IP-connected screen(s) and mobile electronic device(s). The module may be a web-based or browser-based application or module or plug-in or extension, or a stand-alone program or application. The module may comprise or may utilize a main menu or a sequence of main operations, for example, initial configuration, defining of assets, defining of logic, IP-connected screen-side design, end-user side design, review interactive application, and submit or share or upload the interactive application.

For example, a designer may select a type or template of interactive application (e.g., a survey application; a virtual bowling application; a virtual basketball hoops application; a virtual soccer-kicking application; or the like). The designer may select or define or customize the Flow settings for the interactive application; for example, whether the end-user controls the end-user module by hand-motion or by tapping or by on-screen operations or button clicking or “swipe” gestures (or a combination of multiple methods); whether the flow or the progress between events is based on velocity or on timing or takes into account a pseudo-random value (or a combination of methods); the number of levels or iterations in the interactive application; and other flow-related settings and definitions.

The designer may further define and customize the call-to-action method(s), for example, whether a coupon would be generated and then presented or delivered to the end-user (e.g., allowing the user to upload a graphic file representing a coupon; or allowing the user to connect the interactive application to a couponing sub-system or module); whether a redirection of the end-user would occur (e.g., to a pre-defined web-site or web-page or other virtual destination); or other suitable calls-to-action (e.g., directing the user to “share” the experience with other users, or to post about the experience in a social networking website or a blog or micro-blog).

The designer may select one or more authentication methods from a pre-defined list; for example, using a social network login, using email, using an avatar, skipping authentication and proceeding as a guest, or a combination of methods. The designer may proceed to define or upload digital assets (e.g., graphic files, video files, audio files, text items); for example, an initial screen-side video to attract the user(s) eyeballs to the IP-connected screen; an engagement video to be shown after the user connected to the interactive application; a set of videos (or, a set of groups-of-videos) to be shown after the user performs a particular gesture or motion or selection or other user feedback (e.g., each defined gesture triggering a different video, or a different group-of-videos).

The designer may proceed to define the IP-connected screen side design, with suitable logo, greeting text, website URL, an optional QR code, and/or other elements. The designer may then proceed to define the mobile-side screen design, including a “welcome” screen, one or more “action” screens, one or more “outcome” screens that are related to one or more of the action screens, and/or other elements.

The designer may then review the interactive application for testing and/or debugging purposes; and may go back and edit or customize or modify the previously-defined elements. The interactive application may then be submitted or sent to one or more destinations; for example, to a virtual folder or cabinet of the designer; to a cloud-based repository; to a particular client; to a supervisor; or the like. Other suitable operations may be used, in other suitable order or sequence.

Some embodiments may provide a device, system, and method of interactive communications among mobile devices and Internet Protocol (IP) connected screens. A system enables rapid and efficient generation of an interactive application, that has a screen-side component able to run on IP-connected screen, and that has a mobile-side component able to run on smartphones, tablets, smart-watches, and other mobile electronic devices. User feedback from an end-user device, or aggregated user feedback from multiple end-user devices, interacts with and affects the interactive application as displayed on the IP-connected screen. The system enables the interactive application to run and to operate automatically at a sports venue, a digital billboard or digital sign, or at other suitable venues.

In some embodiments of the present invention, a method may comprise: automatically generating an interactive application which enables wireless interaction between an Internet Protocol (IP) connected screen and one or more mobile electronic devices, by performing: (a) generating a controller module able to control on-screen interactions on said IP-connected screen, wherein the controller module comprises one or more user-interface-elements able to trigger performance of one or more respective on-screen interactions; (b) receiving from a designer of said application, a set of graphical representations of on-screen items intended to appear in said application; (c) based on user input from said designer, selectively associating between each graphical representation and one or more interactions in said application; (d) automatically generating said application by generating code that represents at least: said controller module, said one or more user-interface-elements, said graphical representations, said one or more interactions, and said associations between graphical representations and interactions in the application.

In some embodiments, the method may comprise: enabling wireless communication between a mobile electronic device and an Internet Protocol (IP) connected screen, by performing: (a) displaying on the IP-connected screen a pointer to a web-based application accessible through the Internet and associated with both (i) said IP-connected screen and (ii) a server that is associated with said IP-connected screen; (b) wirelessly receiving a signal indicating that said mobile electronic device is accessing said web-based application; (c) establishing a first full-duplex wireless communication link between said server and said mobile electronic device; (d) establishing a second full-duplex wireless communication link between said server and said IP-connected screen; (e) at said server, relaying data between said IP-connected screen and said mobile electronic device.

In some embodiments, the relaying comprises: (A) at said server, wirelessly receiving from said mobile electronic device, through said first full-duplex wireless communication link, a first wireless communication signal indicating user input entered on said mobile electronic device; (B) at said server, wirelessly transmitting to said IP-connected screen, through said second full-duplex wireless communication link, a second wireless communication signal representing said user input; (C) at said web-based application, modifying a display shown on said IP-connected screen based on said user input.

In some embodiments, the method may comprise: enabling wireless communication between (i) an Internet Protocol (IP) connected screen, and (ii) a plurality of mobile electronic devices, by performing: (a) running an application on a server associated with said IP-connected screen, wherein the application causes said IP-connected screen to respond to aggregated user inputs that are received wirelessly from said plurality of mobile electronic devices; (b) sending wirelessly from said server to said plurality of mobile electronic devices, data representing a current state of said application; (c) receiving wirelessly at said server, from said mobile electronic devices, a plurality of wireless communication signals representing user inputs of users of said mobile electronic devices; (d) aggregating said user inputs to generate an aggregated audience feedback; (e) causing said IP-connected screen to modify a display shown on said IP-connected screen, in response to said aggregated audience feedback.

In some embodiments, the method may comprise: enabling wireless communication at a venue, between (i) an Internet Protocol (IP) connected screen, and (ii) a plurality of mobile electronic devices, by performing: (a) running an application on a server associated with said IP-connected screen, wherein the application causes said IP-connected screen to respond to aggregated user inputs that are received wirelessly from said plurality of mobile electronic devices; (b) sending wirelessly from said server to said plurality of mobile electronic devices, data representing a current state of said application; wherein the sending is performed by utilizing WebSockets protocol; (c) receiving wirelessly at said server, from said mobile electronic devices, a plurality of wireless communication signals representing user inputs of users of said mobile electronic devices; (d) continuously estimating cellular network conditions at said venue; (e) determining whether or not the estimated cellular network conditions at said venue are below a pre-defined threshold; (f) if it is determined that the estimated cellular network conditions at said venue are below the pre-defined threshold, then: in a subsequent iteration of sending data wirelessly from said server to said mobile electronic devices, sending said data by utilizing polling instead of WebSockets; (g) if it is determined that the estimated cellular network conditions at said venue are not below the pre-defined threshold, then: in a subsequent iteration of sending data wirelessly from said server to said mobile electronic devices, sending said data by utilizing WebSockets.

In some embodiments, said IP-connected screen comprises a plurality of IP-connected screens that are co-located within a single venue; wherein the method comprises: based on user feedback received from one or more mobile end-user devices, updating displays shown on said plurality of IP-connected screens that are co-located within said single venue.

In some embodiments, said IP-connected screen comprises a plurality of IP-connected screens that are distributed across multiple venues; wherein the method comprises: based on user feedback received from one or more mobile end-user devices, updating displays shown on said plurality of IP-connected screens that are distributed across multiple venues.

In some embodiments, the method may comprise: maintaining a screen-side module of said interactive application in stand-by mode; (B) receiving a wireless communication signal indicating that an end-user of a mobile device is accessing a user-side module of said interactive application; (C) in response to said wireless communication signal, switching said interactive application from stand-by mode to operational mode in which said screen-side module of the interactive application responds to user input provided through said user-side module of said interactive application.

In some embodiments, the method may comprise: (A) maintaining a screen-side module of said interactive application in stand-by mode; (B) receiving a wireless communication signal indicating that an end-user of a mobile device is accessing a pre-defined URL that hosts a web-based user-side module of said interactive application; (C) in response to said wireless communication signal, switching said interactive application from stand-by mode to operational mode in which said screen-side module of the interactive application responds to user input provided through said web-based user-side module of said interactive application.

In some embodiments, the method may comprise: (A) maintaining a screen-side module of said interactive application in stand-by mode; (B) receiving a wireless communication signal indicating that an end-user of a mobile device is accessing a Quick Response (QR) code that points to an Internet address that hosts a web-based user-side module of said interactive application; (C) in response to said wireless communication signal, switching said interactive application from stand-by mode to operational mode in which said screen-side module of the interactive application responds to user input provided through said web-based user-side module of said interactive application.

In some embodiments, the method may comprise: (A) maintaining a screen-side module of said interactive application in stand-by mode; (B) while the screen-side module of said interactive application is in stand-by mode, discarding input that end-users transmit wirelessly through mobile end-user devices; (C) at a pre-defined time-point, switching said interactive application from stand-by mode to operational mode in which said screen-side module of the interactive application responds to user input provided through web-based user-side module of said interactive application.

In some embodiments, the method may comprise: (A) maintaining a screen-side module of said interactive application in stand-by mode; (B) while the screen-side module of said interactive application is in stand-by mode, discarding input that end-users transmit wirelessly through mobile end-user devices; (C) periodically checking if a pre-defined condition holds true; (D) upon determining that said pre-defined condition holds true, switching said interactive application from stand-by mode to operational mode in which said screen-side module of the interactive application responds to user input provided through web-based user-side module of said interactive application.

In some embodiments, the method may comprise: establishing an interactions protocol that enables real-time two-way interaction between said mobile end-user devices and said IP-connected screen.

In some embodiments, the interactions protocol is to perform: (A) authentication of end-user devices; and/or (B) authentication of said IP-connected screen; and/or (C) handling of queue of end-user devices; and/or (D) handling of outcome of aggregated feedbacks received from end-user devices; and/or (E) transmitting of in-application notifications to end-user devices.

Some embodiments of the present invention may utilize suitable hardware components and/or software modules, which may be part of servers, computers, databases, repositories, mobile devices, or other units; and may include, for example, processors, memory units, storage units, input units (keyboard, mouse, touch-screen, etc.), output units (screen, speakers, etc.), wireless transceivers and/or wired transceivers, modems, Network Interface Cards (NICs), network adapters, network elements, Operating Systems, drivers, software applications, or the like.

Functions, operations, components and/or features described herein with reference to one or more embodiments of the present invention, may be combined with, or may be utilized in combination with, one or more other functions, operations, components and/or features described herein with reference to one or more other embodiments of the present invention.

While certain features of the present invention have been illustrated and described herein, many modifications, substitutions, changes, and equivalents may occur to those skilled in the art. Accordingly, the claims are intended to cover all such modifications, substitutions, changes, and equivalents.

1. A method comprising:
automatically generating an interactive application which enables wireless interaction between an Internet Protocol (IP) connected screen and one or more mobile electronic devices, by performing:
(a) generating a controller module able to control on-screen interactions on said IP-connected screen, wherein the controller module comprises one or more user-interface-elements able to trigger performance of one or more respective on-screen interactions;
(b) receiving from a designer of said application, a set of graphical representations of on-screen items intended to appear in said application;
(c) based on user input from said designer, selectively associating between each graphical representation and one or more interactions in said application;
(d) automatically generating said application by generating code that represents at least: said controller module, said one or more user-interface-elements, said graphical representations, said one or more interactions, and said associations between graphical representations and interactions in the application.

2. The method according to claim 1, comprising:
enabling wireless communication between a mobile electronic device and an Internet Protocol (IP) connected screen, by performing:
(a) displaying on the IP-connected screen a pointer to a web-based application accessible through the Internet and associated with both (i) said IP-connected screen and (ii) a server that is associated with said IP-connected screen;
(b) wirelessly receiving a signal indicating that said mobile electronic device is accessing said web-based application;
(c) establishing a first full-duplex wireless communication link between said server and said mobile electronic device;
(d) establishing a second full-duplex wireless communication link between said server and said IP-connected screen;
(e) at said server, relaying data between said IP-connected screen and said mobile electronic device.

3. The method of claim 2, wherein the relaying comprises:
(A) at said server, wirelessly receiving from said mobile electronic device, through said first full-duplex wireless communication link, a first wireless communication signal indicating user input entered on said mobile electronic device;
(B) at said server, wirelessly transmitting to said IP-connected screen, through said second full-duplex wireless communication link, a second wireless communication signal representing said user input;
(C) at said web-based application, modifying a display shown on said IP-connected screen based on said user input.

4. The method of claim 1, comprising:
enabling wireless communication between (i) an Internet Protocol (IP) connected screen, and (ii) a plurality of mobile electronic devices, by performing:
(a) running an application on a server associated with said IP-connected screen, wherein the application causes said IP-connected screen to respond to aggregated user inputs that are received wirelessly from said plurality of mobile electronic devices;
(b) sending wirelessly from said server to said plurality of mobile electronic devices, data representing a current state of said application;
(c) receiving wirelessly at said server, from said mobile electronic devices, a plurality of wireless communication signals representing user inputs of users of said mobile electronic devices;
(d) aggregating said user inputs to generate an aggregated audience feedback;
(e) causing said IP-connected screen to modify a display shown on said IP-connected screen, in response to said aggregated audience feedback.

5. A method comprising:
enabling wireless communication at a venue, between (i) an Internet Protocol (IP) connected screen, and (ii) a plurality of mobile electronic devices, by performing:
(a) running an application on a server associated with said IP-connected screen, wherein the application causes said IP-connected screen to respond to aggregated user inputs that are received wirelessly from said plurality of mobile electronic devices;
(b) sending wirelessly from said server to said plurality of mobile electronic devices, data representing a current state of said application; wherein the sending is performed by utilizing WebSockets protocol;
(c) receiving wirelessly at said server, from said mobile electronic devices, a plurality of wireless communication signals representing user inputs of users of said mobile electronic devices;
(d) continuously estimating cellular network conditions at said venue;
(e) determining whether or not the estimated cellular network conditions at said venue are below a pre-defined threshold;
(f) if it is determined that the estimated cellular network conditions at said venue are below the pre-defined threshold, then: in a subsequent iteration of sending data wirelessly from said server to said mobile electronic devices, sending said data by utilizing polling instead of WebSockets;
(g) if it is determined that the estimated cellular network conditions at said venue are not below the pre-defined threshold, then: in a subsequent iteration of sending data wirelessly from said server to said mobile electronic devices, sending said data by utilizing WebSockets.

6. The method of claim 5, wherein said IP-connected screen comprises a plurality of IP-connected screens that are co-located within a single venue; wherein the method comprises:
based on user feedback received from one or more mobile end-user devices, updating displays shown on said plurality of IP-connected screens that are co-located within said single venue.

7. The method of claim 5, wherein said IP-connected screen comprises a plurality of IP-connected screens that are distributed across multiple venues; wherein the method comprises:
based on user feedback received from one or more mobile end-user devices, updating displays shown on said plurality of IP-connected screens that are distributed across multiple venues.

8. The method of claim 5, comprising:
(A) maintaining a screen-side module of said interactive application in stand-by mode;
(B) receiving a wireless communication signal indicating that an end-user of a mobile device is accessing a user-side module of said interactive application;
(C) in response to said wireless communication signal, switching said interactive application from stand-by mode to operational mode in which said screen-side module of the interactive application responds to user input provided through said user-side module of said interactive application.

9. The method of claim 5, comprising:
(A) maintaining a screen-side module of said interactive application in stand-by mode;
(B) receiving a wireless communication signal indicating that an end-user of a mobile device is accessing a pre-defined URL that hosts a web-based user-side module of said interactive application;
(C) in response to said wireless communication signal, switching said interactive application from stand-by mode to operational mode in which said screen-side module of the interactive application responds to user input provided through said web-based user-side module of said interactive application.

10. The method of claim 5, comprising:
(A) maintaining a screen-side module of said interactive application in stand-by mode;
(B) receiving a wireless communication signal indicating that an end-user of a mobile device is accessing a Quick Response (QR) code that points to an Internet address that hosts a web-based user-side module of said interactive application;
(C) in response to said wireless communication signal, switching said interactive application from stand-by mode to operational mode in which said screen-side module of the interactive application responds to user input provided through said web-based user-side module of said interactive application.

11. The method of claim 5, comprising:
(A) maintaining a screen-side module of said interactive application in stand-by mode;
(B) while the screen-side module of said interactive application is in stand-by mode, discarding input that end-users transmit wirelessly through mobile end-user devices;
(C) at a pre-defined time-point, switching said interactive application from stand-by mode to operational mode in which said screen-side module of the interactive application responds to user input provided through web-based user-side module of said interactive application.

12. The method of claim 5, comprising:
(A) maintaining a screen-side module of said interactive application in stand-by mode;
(B) while the screen-side module of said interactive application is in stand-by mode, discarding input that end-users transmit wirelessly through mobile end-user devices;
(C) periodically checking if a pre-defined condition holds true;
(D) upon determining that said pre-defined condition holds true, switching said interactive application from stand-by mode to operational mode in which said screen-side module of the interactive application responds to user input provided through web-based user-side module of said interactive application.

13. The method of claim 5, comprising:
establishing an interactions protocol that enables real-time two-way interaction between said mobile end-user devices and said IP-connected screen.

14. The method of claim 13, wherein the interactions protocol is to perform:
(A) authentication of end-user devices;
(B) authentication of said IP-connected screen.

15. The method of claim 13, wherein the interactions protocol is to perform:
(A) handling of queue of end-user devices;
(B) handling of outcome of aggregated feedbacks received from end-user devices;
(C) transmitting of in-application notifications to end-user devices.

16. The method of claim 1, comprising:
enabling wireless communication at a venue, between (i) an Internet Protocol (IP) connected screen, and (ii) a plurality of mobile electronic devices, by performing:
(A) running an application on a server associated with said IP-connected screen, wherein the application causes said IP-connected screen to respond to aggregated user inputs that are received wirelessly from said plurality of mobile electronic devices;
(B) sending wirelessly from said server to said plurality of mobile electronic devices, data representing a current state of said application; wherein the sending is performed by utilizing WebSockets protocol;
(C) receiving wirelessly at said server, from said mobile electronic devices, a plurality of wireless communication signals representing user inputs of users of said mobile electronic devices;
(D) continuously estimating cellular network conditions at said venue;
(E) determining whether or not the estimated cellular network conditions at said venue are below a pre-defined threshold;
(F) if it is determined that the estimated cellular network conditions at said venue are below the pre-defined threshold, then: in a subsequent iteration of sending data wirelessly from said server to said mobile electronic devices, sending said data by utilizing polling instead of WebSockets;
(G) if it is determined that the estimated cellular network conditions at said venue are not below the pre-defined threshold, then: in a subsequent iteration of sending data wirelessly from said server to said mobile electronic devices, sending said data by utilizing WebSockets.

17. The method of claim 1, wherein said IP-connected screen comprises a plurality of IP-connected screens that are co-located within a single venue; wherein the method comprises:
based on user feedback received from one or more mobile end-user devices, updating displays shown on said plurality of IP-connected screens that are distributed across multiple venues.

18. The method of claim 1, comprising:
(A) maintaining a screen-side module of said interactive application in stand-by mode;
(B) receiving a wireless communication signal indicating that an end-user of a mobile device is accessing a pre-defined URL that hosts a web-based user-side module of said interactive application;
(C) in response to said wireless communication signal, switching said interactive application from stand-by mode to operational mode in which said screen-side module of the interactive application responds to user input provided through said web-based user-side module of said interactive application.

19. The method of claim 1, comprising:
(A) maintaining a screen-side module of said interactive application in stand-by mode;
(B) receiving a wireless communication signal indicating that an end-user of a mobile device is accessing a Quick Response (QR) code that points to an Internet address that hosts a web-based user-side module of said interactive application;
(C) in response to said wireless communication signal, switching said interactive application from stand-by mode to operational mode in which said screen-side module of the interactive application responds to user input provided through said web-based user-side module of said interactive application.

20. The method of claim 1, comprising:
establishing an interactions protocol that enables real-time two-way interaction between said mobile end-user devices and said IP-connected screen;
wherein the interactions protocol is to perform:
(A) authentication of end-user devices;
(B) authentication of said IP-connected screen.
(C) handling of queue of end-user devices;
(D) handling of outcome of aggregated feedbacks received from end-user devices;
(E) transmitting of in-application notifications to end-user devices.
